(19) United States
(12) Patent Application Publication
(10) Pub. No.: US 2026/0011257 A1
(43) Pub. Date: Jan. 8, 2026

(54) CONVERSATIONAL PRACTICE ASSISTANT

(71) Applicant: Starkey Laboratories, Inc., Eden Prairie, MN (US)

(72) Inventors: Jon Kindred, Minneapolis, MN (US); David A. Fabry, Eden Prairie, MN (US); Dean G. Meyer, Mound, MN (US)

(21) Appl. No.: 19/198,505

(22) Filed: May 5, 2025

Related U.S. Application Data
(60) Provisional application No. 63/667,938, filed on Jul. 5, 2024.

(51) Int. Cl. G09B 5/04; G10L 13/02; G10L 15/183; G10L 15/22; G10L 25/63

(52) U.S. Cl. CPC G09B 5/04; G10L 13/02; G10L 15/183; G10L 15/22; G10L 25/63

(57) ABSTRACT

A conversational practice assistant may provide a conversational prompt initiator to initiate an interactive conversation with a user, the conversational prompt initiator comprising one or more natural language phrases determined based on learned information about the user. The conversational practice assistant may receive, via a microphone on the ear-wearable device, an audio input corresponding to a user response to the conversation initiator.

This application claims the benefit of U.S. Provisional Patent Application No. 63/667,938, filed 5 Jul. 2024, the entire contents of which is incorporated herein by reference.

### TECHNICAL FIELD

This disclosure relates to ear-wearable devices.

### BACKGROUND

Ear-wearable devices are devices designed to be worn on, in, or near one or more of a user's ears. Common types of ear-wearable devices include hearing assistance devices (e.g., “hearing aids”, “hearing instruments”), earbuds, headphones, hearables, cochlear implants, and so on. In some examples, an ear-wearable device may be implanted or integrated into a user. Some ear-wearable devices include additional features beyond just environmental sound-amplification. For example, some modern ear-wearable devices include advanced audio processing for improved functionality, controlling and programming the ear-wearable devices, wireless communication with external devices including other ear-wearable devices (e.g., for streaming media), and so on.

### SUMMARY

In general, this disclosure describes techniques related to the use of artificial intelligence to provide a conversational practice assistant for users of ear-wearable devices. In accordance with one or more techniques of this disclosure, the conversational practice assistant may operate in an interactive mode to engage an ear-wearable device user in a conversation. Engaging in such conversations may help users who may be experiencing memory or cognitive issues.

A conversational practice assistant is designed to generally increase the person's overall mental health and acuity, and more specifically to help the hearing aid wearer achieve better engagement in the world through better mental acuity achieved through conversational practice. This may be done by extracting information about the user (wearer of the hearing aid), and then using the extracted information to generate a conversation initiator that is relevant and interesting to the user. The selection of topics of specific personal interest to the wearer may encourage the user to engage in conversational practice, facilitate memory retention based on engagement with activities and topics that are relevant and personally important in their life, or both.

In an example, a method of delivering conversational practice through an ear-wearable device includes providing, by the ear-wearable device, a conversation initiator to initiate an interactive conversation with a user, the conversation initiator comprising one or more natural language phrases determined based on learned information about the user; and receiving, via a microphone on the ear-wearable device, an audio input corresponding to a user response to the conversation initiator.

In another example, a conversational practice assistant system includes an car-wearable device, wherein the ear-wearable device includes a memory; and one or more programmable processors in communication with the memory, and configured to: provide a conversation initiator to initiate an interactive conversation with a user, the conversation initiator comprising one or more natural language phrases determined based on learned information about the user; and receive, via a microphone on the ear-wearable device, an audio input corresponding to a user response to the conversation initiator.

In another example, non-transitory computer-readable media is configured with instructions to cause one or more one or more processors to provide a conversation initiator to initiate an interactive conversation with a user, the conversation initiator comprising one or more natural language phrases determined based on learned information about the user; and receive, via a microphone on an ear-wearable device, an audio input corresponding to a user response to the conversation initiator.

In yet another example, this disclosure describes a method includes providing, by a local computing system associated with a user, a virtual personal assistant configured to conduct an interactive conversation with the user, wherein the interactive conversation includes a series of dialog pairs, each of the dialog pairs includes one or more expressions by the user and one or more expressions by the virtual personal assistant, and providing the virtual personal assistant comprises, for at least one dialog pair of the series of dialog pairs: receiving, by the local computing system, user expression data from one or more ear-wearable devices worn by the user, wherein the user expression data represents a first expression of the user in the dialog pair; retrieving, by the local computing system, user-specific data from a knowledge base associated with the user; generating, by the local computing system, based on the user-specific data and the user expression data, an augmented prompt that requests a generative artificial intelligence (AI) system to generate a second expression of the virtual personal assistant in the dialog pair; obtaining, by the local computing system, the second expression of the virtual personal assistant from the generative AI system; and causing, by the local computing system, the one or more car-wearable devices to output audio based on the second expression of the virtual personal assistant.

In another example, this disclosure describes local computing system associated with a user, comprises a memory; and one or more programmable processors in communication with the memory, and configured to provide a conversational practice assistant configured to conduct an interactive conversation with the user, wherein the interactive conversation includes a series of dialog pairs, each of the dialog pairs includes one or more expressions by the user and one or more expressions by the conversational practice assistant, and to provide the conversational practice assistant the one or more programmable processors are configured to, for at least one dialog pair of the series of dialog pairs: receive user expression data from one or more ear-wearable devices worn by the user, wherein the user expression data represents a first expression of the user in the dialog pair, and the local computing system is associated with the user; retrieve user-specific data from a knowledge base associated with the user; generate, based on the user-specific data and the user expression data, an augmented prompt that requests a generative artificial intelligence (AI) system to generate a second expression of the conversational practice assistant in the dialog pair; obtain the second expression of the conversational practice assistant from the generative AI system; and cause the one or more ear-wearable devices to output audio based on the second expression of the conversational practice assistant.

In another example, this disclosure describes one or more non-transitory computer-readable media, includes instructions stored thereon that, when executed, cause one or more processors of a computing system to conduct an interactive conversation with a user, wherein the interactive conversation includes a series of dialog pairs, each of the dialog pairs includes one or more expressions by the user and one or more expressions by the conversational practice assistant, and to provide the conversational practice assistant the one or more programmable processors are configured to, for at least one dialog pair of the series of dialog pairs: receive user expression data from one or more ear-wearable devices worn by the user, wherein the user expression data represents a first expression of the user in the dialog pair, and the local computing system is associated with the user; retrieve user-specific data from a knowledge base associated with the user; generate, based on the user-specific data and the user expression data, an augmented prompt that requests a generative artificial intelligence (AI) system to generate a second expression of the conversational practice assistant in the dialog pair; obtain the second expression of the conversational practice assistant from the generative AI system; and cause the one or more ear-wearable devices to output audio based on the second expression of the conversational practice assistant.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 is a conceptual diagram illustrating an example system that includes one or more ear-wearable devices, in accordance with one or more techniques of this disclosure.

FIG. 2 is a block diagram illustrating example components of an ear-wearable device, in accordance with one or more techniques of this disclosure.

FIG. 3 is a block diagram illustrating example components of a computing device, in accordance with one or more techniques of this disclosure.

FIG. 4 is a block diagram illustrating example components of a conversational practice assistant, in accordance with one or more techniques of this disclosure.

FIG. 5 is a flowchart illustrating an example operation of the conversational practice assistant, in accordance with one or more techniques described in this disclosure.

FIG. 6 is a flowchart illustrating an example operation, in accordance with one or more techniques of this disclosure.

FIG. 7 is a flowchart illustrating an example operation for delivering conversational practice, in accordance with one or more techniques of this disclosure.

### DETAILED DESCRIPTION

People who experience uncompensated hearing loss are more likely to experience memory loss and cognitive issues. It is understood that such symptoms are a result of less interactive social engagement. The use of ear-wearable devices such as hearing instruments, hearing aids, and other such devices that improve people's hearing can help users be more socially engaged and may help users participate in longer and more complex conversations. Nevertheless, ear-wearable device users who already have some degree of memory loss or cognitive decline may still avoid social engagement and conversations for various reasons, such as a lack of confidence that they will remember important details about past conversations or details about their conversation partners.

This disclosure described techniques in which a computing system implements a conversational practice assistant that is configured to use a generative artificial intelligence (AI) model to engage in an interactive conversation with a user of one or more ear-wearable devices. The conversational practice assistant may generally increase the user's overall mental health and acuity. Further, the conversational practice assistant may help the user of the one or more ear-wearable devices achieve better engagement in the world though improved mental acuity achieved through conversational practice. For example, the conversational practice assistant may help the user practice for a conversation with a specific person or on a specific topic. Engaging in practice conversations with the conversational practice assistant may help the user reinforce memories, build confidence in their conversational abilities, and feel more ready to engage in conversations with real people. In addition, the selection of topics of specific personal interest to the user may both encourage the user to engage in conversational practice, facilitate memory retention based on engagement with activities and topics that are relevant and personally important in their life, or both. Thus, engaging in conversations with the conversational practice assistant may ultimately help users with memory loss, mental acuity, and/or cognitive decline.

For the conversational practice assistant to engage in meaningful interactive conversations, the conversational practice assistant may need access to data that is personal to the user. For example, the conversational practice assistant may need access to information about the user's family members, health conditions, topics of past conversations, future plans, interests, and so on. Thus, in accordance with one or more techniques of this disclosure, a conversational practice assistant may conduct an interactive conversation with the user. The interactive conversation includes a series of dialog pairs, where each of the dialog pairs includes an expression by the user and an expression by the conversational practice assistant. For instance, the user may say something and then the conversational practice assistant may “say” something, or vice versa. The conversational practice assistant may, for at least one dialog pair of the series of dialog pairs, receive user expression data from one or more ear-wearable devices worn by the user. The user expression data represents an expression of the user in the dialog pair. The conversational practice assistant may retrieve user-specific data from a knowledge base associated with the user. The conversional practice assistant may generate, based on the user-specific data and the user expression data, an augmented conversation initiator that requests a generative AI system, such as a large language model (LLM), to generate an expression of the conversational practice assistant in the dialog pair. The generative AI system may be implemented on a remote computing system. Furthermore, the conversational practice assistant may obtain the expression from the generative AI system and cause the one or more ear-wearable devices to output audio based on the expression of the conversational practice assistant. In some examples, a local computing system may provide the conversational practice assistant.

Furthermore, storing such personal information remotely from the user may raise security concerns. For example, users may feel uncomfortable with the personal data being somewhere that they cannot control. Additionally, since health information may be involved, extra measures may be required to comply with privacy regulations. In accordance with a technique of this disclosure, personal data may be stored in a knowledge base in a memory of a local computing system, such as a mobile phone of a hearing instrument user. As such, the personal data is not stored at a location remote from this user. This may augment the security and privacy of the personal data because the personal data is not available on a remote or public server.

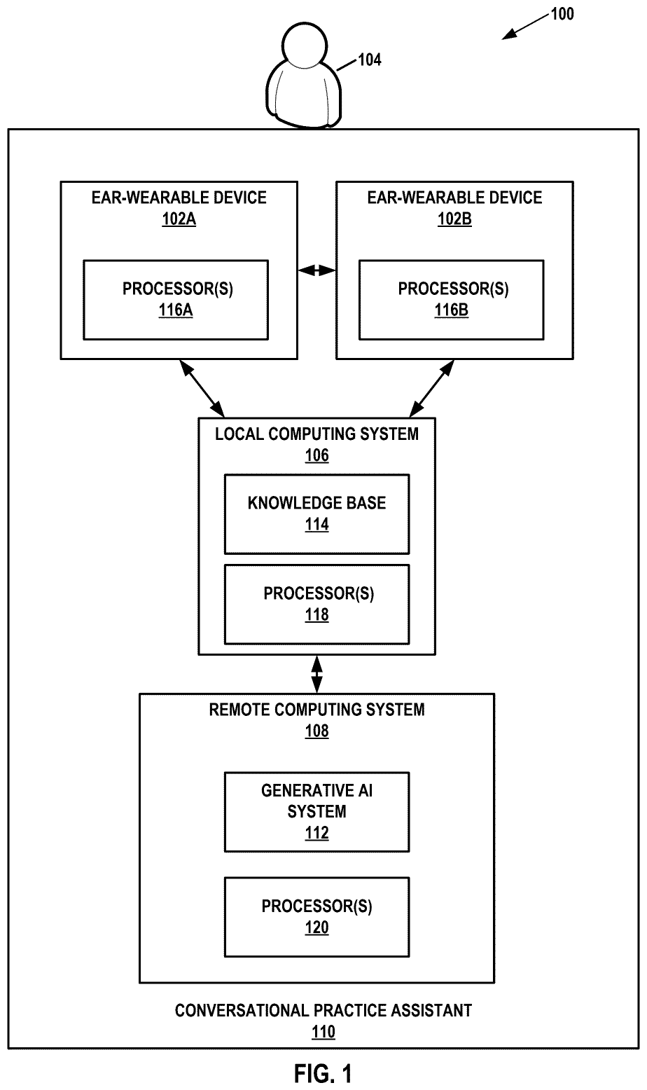

FIG. 1 is a conceptual diagram illustrating an example system 100 that includes ear-wearable devices 102A, 102B, in accordance with one or more techniques of this disclosure. This disclosure may refer to ear-wearable devices 102A and 102B collectively, as “ear-wearable devices 102.” A user 104 may wear ear-wearable devices 102. In some instances, user 104 may wear a single ear-wearable device. In other instances, user 104 may wear two ear-wearable devices, with one ear-wearable device for each car of user 104.

Ear-wearable devices 102 may include one or more of various types of devices that are configured to provide auditory stimuli to user 104 and that are designed for wear and/or implantation at, on, near, or in relation to the physiological function of an car of user 104. Ear-wearable devices 102 may be worn, at least partially, in the car canal or concha. One or more of ear-wearable devices 102 may include behind the car (BTE) components that are worn behind the cars of user 104. In some examples, ear-wearable devices 102 include devices that are at least partially implanted into or integrated with the skull of user 104. In some examples, one or more of ear-wearable devices 102 provides auditory stimuli to user 104 via a bone conduction pathway.

In any of the examples of this disclosure, each of ear-wearable devices 102 may include a hearing assistance device. Hearing assistance devices include devices that help user 104 hear sounds in the environment of user 104. Example types of hearing assistance devices may include hearing aid devices, Personal Sound Amplification Products (PSAPs), cochlear implant systems (which may include cochlear implant magnets, cochlear implant transducers, and cochlear implant processors), bone-anchored or osseointegrated hearing aids, and so on. In some examples, ear-wearable devices 102 are over-the-counter, direct-to-consumer, or prescription devices. Furthermore, in some examples, ear-wearable devices 102 include devices that provide auditory stimuli to user 104 that correspond to artificial sounds or sounds that are not naturally in the environment of user 104, such as recorded music, computer-generated sounds, or other types of sounds. For instance, ear-wearable devices 102 may include so-called “hearables,” earbuds, earphones, or other types of devices that are worn on or near the cars of user 104. Some types of ear-wearable devices provide auditory stimuli to user 104 corresponding to sounds from the user's environment and also artificial sounds. In some examples, car-wearable devices 102 may include cochlear implants or brainstem implants. In some examples, ear-wearable devices 102 may use a bone conduction pathway to provide auditory stimulation. In some examples, one or more of ear-wearable devices 102 includes a housing or shell that is designed to be worn in the car for both aesthetic and functional reasons and encloses the electronic components of the ear-wearable device. Such car-wearable devices may be referred to as in-the-car (ITE), in-the-canal (ITC), completely-in-the-canal (CIC), or invisible-in-the-canal (IIC) devices. In some examples, one or more of ear-wearable devices 102 may be behind-the-car (BTE) devices, which include a housing worn behind the car that contains all of the electronic components of the car-wearable device, including the receiver (e.g., a speaker). The receiver conducts sound to an earbud inside the car via an audio tube. In some examples, one or more of ear-wearable devices 102 are receiver-in-canal (RIC) hearing-assistance devices, which include housings worn behind the cars that contain electronic components and housings worn in the car canals that contain receivers.

Ear-wearable device 102A and ear-wearable device 102B include one or more of processors 116A and processors 116B (hereinafter “processors 116”), respectively. Processors 116 may include one or more types of processors that execute instructions and enable functionality of ear-wearable devices 102. For example, processors 116 may include an integrated processor that processes audio input received by components of car-wearable devices 102.

Ear-wearable devices 102 may implement a variety of features that help user 104 hear better. For example, ear-wearable devices 102 may amplify the intensity of incoming sound, amplify the intensity of certain frequencies of the incoming sound, translate or compress frequencies of the incoming sound, receive wireless audio transmissions from hearing assistive listening systems and hearing aid accessories (e.g., remote microphones, media streaming devices, and the like), and/or perform other functions to improve the hearing of user 104. In some examples, ear-wearable devices 102 implement a directional processing mode in which ear-wearable devices 102 selectively amplify sound originating from a particular direction (e.g., to the front of user 104) while potentially fully or partially canceling sound originating from other directions. In other words, a directional processing mode may selectively attenuate off-axis unwanted sounds. The directional processing mode may help user 104 understand conversations occurring in crowds or other noisy environments. In some examples, ear-wearable devices 102 use beamforming or directional processing cues to implement or augment directional processing modes.

In some examples, ear-wearable devices 102 reduce noise by canceling out or attenuating certain frequencies. Furthermore, in some examples, ear-wearable devices 102 may help user 104 enjoy audio media, such as music or sound components of visual media, by outputting sound based on audio data wirelessly transmitted to ear-wearable devices 102.

Ear-wearable devices 102 may be configured to communicate with each other. For instance, in any of the examples of this disclosure, ear-wearable devices 102 may communicate with each other using one or more wireless communication technologies. Example types of wireless communication technology include Near-Field Magnetic Induction (NFMI) technology, 900 MHz technology, BLUETOOTH™ technology, WI-FI™ technology, audible sound signals, ultrasonic communication technology, infrared communication technology, inductive communication technology, or other types of communication that do not rely on wires to transmit signals between devices. In some examples, ear-wearable devices 102 use a 2.4 GHz frequency band for wireless communication. In examples of this disclosure, ear-wearable devices 102 may communicate with each other via non-wireless communication links, such as via one or more cables, direct electrical contacts, and so on.

As shown in the example of FIG. 1, system 100 may also include a local computing system 106 and a remote computing system 108. In other examples, system 100 does not include one or more of local computing system 106 or remote computing system 108. Each of local computing system 106 and remote computing system 108 may include one or more computing devices, each of which may include one or more processors, such as processors 118 of local computing system 106 and processors 120 of remote computing system 120. In general, local computing system 106 is local to, e.g., carried by, worn by, or otherwise in the vicinity of, user 104. For instance, local computing system 106 may include one or more mobile devices (e.g., smartphones, tablet computers, etc.), handheld devices, wireless access points, smart speaker devices, smart televisions, medical alarm devices, smart key fobs, smartwatches, smart displays, screen-enhanced smart speakers, wireless routers, wireless communication hubs, prosthetic devices, mobility devices, special-purpose devices, accessory devices, and/or other types of devices. Accessory devices may include devices that are configured specifically for use with ear-wearable devices 102. Example types of accessory devices may include charging cases for ear-wearable devices 102, storage cases for ear-wearable devices 102, media streamer devices, phone streamer devices, external microphone devices, external telecoil devices, remote controls for ear-wearable devices 102, and other types of devices specifically designed for use with ear-wearable devices 102. Ear-wearable devices 102 and local computing system 106 may be configured to communicate with one another. In some examples, ear-wearable devices 102 may communicate with local computing system 106 using a BLUETOOTH technology. In some examples, an application running on local computing system 106 may allow users (e.g., user 104) to control and customize ear-wearable devices 102.

Remote computing system 108 may be remote from user 104. Remote computing system 108 may be located in an offsite location remote from user 104 such as a data center. Local computing system 106 may communicate with remote computing system 108 via a communication network, such as the internet. In general, ear-wearable devices 102 do not communicate directly with remote computing system 108. In some examples, remote computing system 108 is a cloud-based computing system. Remote computing system 108 may include one or more computing devices, such as server devices.

In accordance with techniques of this disclosure, an artificial intelligence (AI)-enhanced conversational practice assistant 110 is provided to user 104 via ear-wearable devices 102. Conversational practice assistant 110 comprises one or more computer programs. Conversational practice assistant 110 may be configured to provide personalized conversational practice to user 104. Conversational practice assistant 110 may use one or more large language models (LLMs), natural language processing (NLP) models, or other types of machine learning models to provide the personalized conversational practice to user 104. In some examples, conversational practice assistant 110 may use one or more machine learning models that are executed locally on local computing system 106. In some examples, conversational practice assistant 110 may interact with user 104 to conduct practice conversations with user 104, which may aid user 104 in retaining cognitive performance and warding off cognitive decline, particularly for users who do not have the opportunity to regularly interact with other people.

Ear-wearable devices 102, local computing system 106 and/or remote computing system 108 may work together to provide conversational practice assistant 110. For example, microphones of ear-wearable devices 102 may detect speech and generate audio data, communication units of one or more of ear-wearable devices 102 may transmit the audio data to local computing system 106. Processors 116 of ear-wearable devices 102 may pre-process the audio data. Processors 118 and 120 of local computing system 106 and/or remote computing system 108, respectively may further process the audio data and perform processing functions of conversational practice assistant 110. For instance, in some examples, remote computing system 108 may perform NLP, process voice commands, facilitate adjustments to ear-wearable devices 102, perform updates and diagnostics on ear-wearable devices 102, or perform other functionality of a conversational practice assistant 110. NLP may include speech-to-text, determining intention of speech requests, and otherwise extracting semantic content from natural language expressions. Local computing system 106 may transmit audio data (or semantic content that processors of one or more of ear-wearable devices 102 convert to audio data) to ear-wearable devices 102. Conversational practice assistant 110 may include a processing system that includes processors 116 of ear-wearable devices 102, processors 118 of local computing system 106, and/or processors 120 of remote computing system 108. The processing system may execute the instructions of and provide functionality for conversational practice assistant 110.

Conversational practice assistant 110 may interact with user 104 and conduct conversations with user 104 via ear-wearable devices 102. Conversational practice assistant 110 may be configured to conduct conversations that are between conversational practice assistant 110 and user 104 in addition to conversations that simulate conversations between user 104 and other individuals. For example, conversational practice assistant 110 may conduct a conversation with user 104 regarding one or more topics such as user 104 requesting calendar reminders. In another example, conversational practice assistant 110 conducts a conversation that simulates a conversation between user 104 and a family member of user 104.

In the example of FIG. 1, remote computing system 108 may implement a generative AI system 112. Generative AI system 112 may form part of conversational practice assistant 110. While the example of FIG. 1 illustrates generative AI system 112 as being implemented by remote computing system 108, in other examples, ear-wearable devices 102 or local computing system 106 may additionally or alternatively implement generative AI system 112. Generative AI system 112 may include a large language model (LLM) or other type of system that uses artificial intelligence techniques to generate natural language output, e.g., in response to prompts provided to generative AI system 112. The natural language output may include text data, audio data, or other types of data representing natural language content. In examples where ear-wearable devices 102 include cochlear implants, the natural language output may include electrical signal data that represents one or more electrical signals to stimulate auditory nerves of user 104 so that user 104 recognizes sound of the natural language content. In other examples, generative AI system 112 may be implemented at least partially in local computing system 106 and/or ear-wearable devices 102, or in combination with remote computing system 108.

Conversational practice assistant 110 may use generative AI system 112 to process audio data received by ear-wearable devices 102. Conversational practice assistant 110 may use generative AI system 112 to process the received audio data and determine a response to the audio data. In some examples, conversational practice assistant 110, as part of processing the audio data, converts the received audio data into text. For example, conversational practice assistant 110 may convert audio data received by ear-wearable devices 102 into text of “When is my appointment this week?” Conversational practice assistant 110 may use one or more types of audio conversion processes such as text-to-speech processes to convert audio received by ear-wearable devices 102 into text.

Conversational practice assistant 110 generates prompts for a generative AI system based on the generated text. Conversational practice assistant 110 may generate prompts that are prompts for one or more generative AI systems, such as generative AI system 112. In an example, conversational practice assistant 110 generates a prompt based on the text “When is my appointment this week?” and provides it generative AI system 112. Conversational practice assistant 110 may provide prompts to generative AI system 112 for generative AI system 112 to formulate interactions with user 104. In some examples, conversational practice assistant 110 may generate prompts that include audio data, such as the audio data obtained from ear-wearable devices 102 or modified audio data based on the audio data obtained from ear-wearable devices 102. In some examples, conversational practice assistant 110 may generate prompts that include types of data other than textual data and audio data that represent the audio data obtained from car-wearable devices 102.

Generative AI system 112, based on receiving a prompt, generates output data (e.g., text data, audio data, electrical signal data, etc.) in response to the prompt. Generative AI system 112 may generate output data that represents a response to a question posed by user 104, output data that represents part of a conversation between user 104 and conversational practice assistant 110, and other types of output data. In an example, generative AI system 112 receives a prompt that is based on “When is my appointment this week?” Generative AI system 112 generates response output data indicating “Your appointment is Tuesday at 3 PM,” for inclusion in a response by car-wearable devices 102 to user 104.

In examples where the output data generated by generative AI system 112 includes text, conversational practice assistant 110 may generate audio data based on the text generated by generative AI system 112. Conversational practice assistant 110 may use one or more types of text-to-speech processes, modules, or software components to generate audio data based on the speech. In some examples, local computing system 106 and/or ear-wearable devices 102 may generate audio data based on the text using one or more types of text-to-speech generation or other types of audio conversion. Based on the generation of the audio data, conversational practice assistant 110 may cause car-wearable devices 102 to generate an audio signal (e.g., auditory sounds/speech). In some examples where ear-wearable devices 102 include a cochlear implant, local computing system 106 may generate electrical signal data based on the output data (e.g., text or audio data) generated by generative AI system 112 and transmits the electrical signal data to the cochlear implant. The cochlear implant may convert the electrical signal data into an electrical signal to stimulate an auditory nerve of user 104. In some examples where car-wearable devices 102 include a cochlear implant, local computing system 106 generates audio data based on the output data (e.g., text data) generated by generative AI system 112 and transmits the audio data to the cochlear implant. The cochlear implant may then convert the audio data to one or more electrical signals to stimulate the auditory nerve of user 104.

Ear-wearable devices 102 and/or local computing system 106 may provide one or more indicators to user 104 that conversational practice assistant 110 is active. In addition, ear-wearable devices 102 and/or local computing system 106 may provide indicators that conversational practice assistant 110 is monitoring a conversation and/or ambient noise. Ear-wearable devices 102 and/or local computing system 106 may provide indications that conversational practice assistant 110 is monitoring a conversation or is about to initiate a conversation to reduce user confusion and to provide an indication of privacy. For example, ear-wearable devices 102 may generate an audio chime or other audio indicator to indicate that conversational practice assistant 110 is going to initiate a conversation. In another example, local computing system 106, responsive to an indication by conversational practice assistant 110, may illuminate an indicator (e.g., a light emitting diode (LED)) to indicate that conversational practice assistant is actively monitoring. In yet another example, local computing system 106 may generate a notification that conversational practice assistant 110 is going to initiate a conversion or is actively monitoring.

Conversational practice assistant 110 may use a knowledge base 114 to provide conversational practice assistant functionality. In the example of FIG. 1, local computing system 106 stores store or all of knowledge base 114. In other examples, knowledge base 114 may be stored at least on part on one or more of ear-wearable devices 102, local computing system 106, remote computing system 108, or another system. In some examples, sensitive information of knowledge base 114 may be stored at local computing system 106 and/or ear-wearable devices 102 to help ensure that the sensitive information remains private.

In some examples, generative AI system 112 uses knowledge base 114 to generate responses. Knowledge base 114 may include information about user 104, information about individual people, information about previous conversations, and other types of information. For example, knowledge base 114 may include extracted information about user 104. In some examples, knowledge base 114 may include calendar information. Information may be added to knowledge base 114 over time. For example, generative AI system 112 may generate ontological data based on conversations involving user 104 and conversational practice assistant 110 may add the ontological data to knowledge base 114. In some examples, user 108 and/or other individuals may explicitly provide information for inclusion in knowledge base 114, e.g., a web interface, an application-based interface, a voice interface, or another type of interface. In an example, generative AI system 112 receives a prompt from virtual assistant 110 that includes a prompt to generate a response to question by user 104. The prompt may be augmented with information from knowledge base 114. Thus, the prompt may be referred to as an augmented prompt. Generative AI system 112 processes the augmented prompt to generate a response to the augmented prompt. Generative AI system 112 generates text based on the augmented prompt.

In some examples, conversational practice assistant 110 obtains data from one or more individuals, some of whom may be associated with user 104. For example, conversational practice assistant 110 may obtain information from family members of user 104. Conversational practice assistant 110 may provide a request for information to one or more computing devices associated with a family member or other individual associated with user 104. In some examples, conversational practice assistant 110 may receive information via a webpage configured for family members of user 104 to provide information regarding user 104. Conversational practice assistant 110 may generate a webpage that includes requests for information such as identities of the family members, facts and relationships among the members, important dates such as birthdays and holidays, and other information. Conversational practice assistant 110 may store the obtained information in knowledge base 114 to ensure the correctness of the information and to retain the information for a user with memory loss or other mental incapacities. In some examples, conversational practice assistant 110 may store the information on local computing system 106 in accordance with privacy preferences configured by user 104.

Conversational practice assistant 110 may help user 104 perform activities of daily living, such as providing reminders regarding meetings, appointments, or medications, providing reminders of past interactions with individual people, and so on while conversing with user 104. In some examples, conversational practice assistant 110 may help user 104 control and/or tune ear-wearable devices 102. In some examples, conversational practice assistant 110 may perform telehealth data collection. In additional examples, local computing system 106 may provide relevant information such as a calendar of user 104 to remote computing system 108. In different examples of this disclosure, the processing functions of conversational practice assistant 110 may be distributed among processors of ear-wearable devices 102, local computing system 106, and remote computing system 108 in different ways.

User 104 may initiate interactions and converse with conversational practice assistant 110. For example, user 104 may initiate interactions by speaking an activation word or phrase, pushing a button on one or more of ear-wearable devices 102, providing a command via local computing system 106, or performing some other action. In some examples, conversational practice assistant 110 may initiate an interaction with user 104 without user 104 explicitly initiating the interaction. In other words, in some examples, conversational practice assistant 110 does not need to wait for user 104 to initiate an interaction with conversational practice assistant 110. For instance, conversational practice assistant 110 may initiate a conversation with user 104 to provide reminders to user 104, offer help to user 104, and so on.

Conversational practice assistant 110 may prompt user 104 to engage in conversational practice, such as a practice conversation. Conversational practice assistant 110 may prompt user 104 to engage in conversational practice to provide one or more benefits such as improving the mental acuity of user 104, enabling user 104 to more successfully engage in conversations with other individuals, and other benefits. Conversation practice assistant 110 may generate a conversation initiator to initiate a conversation with user 104 and/or to prompt the user to interact with conversational practice assistant 110. Conversational practice assistant 110 may generate a conversation initiator using one or more hardware and software components such as generative AI system 112, knowledge base 114, and/or one or more processors. For example, conversational practice assistant 110 may generate a conversation initiator that comprises natural language phrases determined based on learned information regarding user 104 (e.g., information from knowledge base 114). Conversational practice assistant 110 may generate conversational initiators that includes one or more natural language phrases that prompt user 104 to engage in conversation with conversational practice assistant 110. For instance, conversational practice assistant 110 may generate a conversation initiator includes a question for user 104 intended to entice user 104 in conversation with conversational practice assistant 110. In an example, conversational practice assistant 110 determines that user 104 may benefit from conversational practice. Conversational practice assistant 110 generates a conversation initiator that includes the natural language of “Your calendar says that you're going to meet your nephew Simon for lunch in a few hours, do you want to practice a simulated conversation with him?” In another example, conversational practice assistant 110 may generate a conversation initiator that includes the natural language phrase of “It sounds like you are not busy at the moment. Would you like to chat about your relatives and what they have been up to lately?”

Conversational practice assistant 110 may provide the conversation initiator to user 104. Conversational practice assistant 110 may provide the conversation initiator to user 104 via one or more components such as a receiver of ear-wearable devices 102. For example, conversational practice assistant 110 may provide the conversation initiator via causing a receiver of ear-wearable device 102A to generate audio of the conversation initiator.

Conversational practice assistant 110 may receive a response by user 104 to the conversation initiator. Conversational practice assistant 110 may receive a response via one or more components such as a microphone of ear-wearable devices 102. Conversational practice assistant 110 may receive the response as an audio input that corresponds to a response to the conversation initiator by user 104. For example, conversation practice assistant 110 may receive audio input consistent with user 104 saying “I am ready to practice a conversation,” via a microphone of ear-wearable device 102B that corresponds to user 104 responding to a conversation initiator.

Conversational practice assistant 110 may use data about user 104. Conversational practice assistant 110 may use data such as events of a calendar, personal information of user 104, information obtained from family members of user 104, and other information, including information stored in knowledge base 114. Conversational practice assistant 110 may obtain the information from one or more computing devices and systems such as local computing system 106 and remote computing system 108. In some examples, conversational practice assistant 110 may obtain information in response to a user interaction. In additional examples, conversational practice assistant 110 may proactively obtain information before interacting with user 104 (e.g., conversational practice assistant 110 obtains an update from the calendar of user 104 before providing event reminders to user 104). In further examples conversational practice assistant 110 may obtain information that is stored locally to local computing system 106 for privacy reasons.

Conversational practice assistant 110 may adjust data collection based on one or more factors. Thus, conversational practice assistant 110 may determine, based on one or more factors, whether to store information in knowledge base 114. For example, conversational practice assistant 110 may determine that user 104 is discussing sensitive topics and refrain from recording the discussion. In an example, user 104 may configure the settings of conversational practice assistant 110 to refrain from monitoring medical and therapeutic-related conversations such as a therapeutic session that user 104 is currently in. Conversational practice assistant 110, while monitoring a conversation between user 104 and another individual, determines that user 104 is discussing medical treatment based on one or more words or phrases identified within the conversation and refrains from further monitoring. In another example, conversational practice assistant 110, based on one or more words or phrases identified by the conversation, refrains from recording the discussion in accordance with one or more privacy settings of the conversational practice assistant 110. In addition, user 104 may configure conversational practice assistant 110 to only monitor conversations when prompted. In an example, user 104 configures conversational practice assistant 110 to operate in a limited-listening mode, where conversational practice assistant 110 only listens when prompted. Conversational practice assistant 110 listens to audio, via ear-wearable devices 102, in response receiving an indication that conversational practice assistant 110 should listen to the audio. For example, conversational practice assistant 110 may monitor a conversation, via ear-wearable devices 102, in response to user 104 providing an indication to ear-wearable devices 102 (e.g., tapping a button on ear-wearable devices 102, verbally stating a command to listen, providing user input to local computing system 106, etc.). In another example, conversational practice assistant 110 may monitor a conversation in response to identifying the voice of a particular individual that user 104 has indicated that conversational practice assistant 110 should listen to.

Conversational practice assistant 110 may modify responses to user interactions based on one or more factors. For example, conversational practice assistant 110 may modify responses based on cultural and political preferences of user 104. In another example, user 104 may configure conversational practice assistant 110 to modify responses based on their cultural and/or other personal preferences. In yet another example, conversational practice assistant 110 may enable individuals associated with user 104 to indicate, via a webpage or companion app, topics that may upset user 104 or that conversational practice assistant 110 may wish to avoid discussing with user 104. Conversational practice assistant 110 may tailor conversation initiators based on responses by user 104. For example, conversational practice assistant 110 may determine that user 104 does not wish to discuss a particular topic based on audio input corresponding to user 104 stating “I don't like talking about that.”

Conversational practice assistant 110 may generate and/or tailor generated conversation initiators and/or other parts of a conversation. Conversational practice assistant 110 may generate conversation initiators and parts of conversations based on one or more factors in order to generate prompts that pertain to topics that are relevant and/or interesting to user 104. Conversational practice assistant 110 may generate prompts that are relevant and/or of interest to encourage user 104 to engage in conversational practice, facilitate memory retention based on engagement with activities and topics that are relevant and personally important in their life, or both. For example, conversational practice assistant 110 may determine a topic that is likely to be of personal interest to the user and generate a conversation initiator that pertains to the determined topic of interest. Conversational practice assistant 110 may determine topics of interest such as a planned event such as a birthday party, sporting event, or artistic performance, information about family member, such as an event in which the family member will take part (e.g. a school play or university attendance) or an accomplishment by the family member (e.g., a sports victory), a recorded memory, a new person with whom the user becomes familiar, and/or other topics. Conversational practice assistant 110 may use the topics of interest to capture the interest of user 104 and incentivize user 104 to engage with conversational practice assistant 110.

In some examples, conversational practice assistant 110 may preemptively ask questions and initiate dialogue with user 104. Conversational practice assistant 110 may use data from ear-wearable devices 102 to monitor the environment around user 104 and determine whether it is appropriate to initiate an interaction with user 104. Conversational practice assistant 110 may determine an initiator delivery time based on an availability of user 104 to participate in conversational practice. Conversational practice assistant 110 may determine an initiator delivery time that is a particular time that conversational practice assistant 110 will provide the conversation initiator to user 104. Conversational practice assistant 110 may use one or more factors to determine whether initiating a session or interaction with user 104 would be appropriate and/or to determine an initiator delivery time. Conversational practice assistant 110 may use factors such as an indication from user 104 that user 104 is open to conversation, a loneliness metric, a determined time window based on calendar availability of user 104, a determined time window based on a learned pattern of availability, environmental conditions consistent with user 104 not being currently active, a recent or present lack of engagement in conversation, and/or a classification of present and/or recent activity associated with user 104.

Conversational practice assistant 110 may determine whether user 104 has a present and/or recent lack of engagement in conversation. For example, conversational practice assistant 110 may determine that user 104 has not interacted with another person for more than five hours. Conversational practice assistant 110 may use an own voice detection algorithm to identify the voice of user 104 and determine whether user 104 has engaged in conversation. Further information regarding own voice detection algorithms may be found in U.S. Pat. No. 8,477,973, which is hereby incorporated by reference in its entirety. In addition, further information regarding determining a lack of engagement in conversation may be found in U.S. Pat. No. 10,674,285, which is hereby incorporated by reference in its entirety.

Conversational practice assistant 110 may use a classification of present and/or recent activity associated with present and/or recent activity of user 104. Conversational practice assistant 110 may generate a classification of the activity of user 104 using one or more techniques and/or sources of information. For example, conversational practice assistant 110 may use data from one or more sensors of ear-wearable devices 102. In addition, conversational practice assistant 110 may use activity classification determined using inputs such as inputs from an inertial motion unit (IMU) of ear-wearable devices 102, audio input, and/or other inputs. For example, conversational practice assistant 110 may generate a classification using audio input captured by one or more components of ear-wearable devices 102. Conversational practice assistant 110 may use one or more machine learning models such as deep neural network (DNN) to generate the classification. For example, conversational practice assistant 110 may provide input data generated by one or more components of ear-wearable devices 102 to a DNN and receive a classification as output from the DNN. Further information regarding using a machine learning model to classify data may be found in Patent Cooperation Treaty (PCT) Publication Number WO2021138648A1, which is hereby incorporated by reference in its entirety.

Conversational practice assistant 110 may use contextual information to determine whether to initiate an interactive conversation with user 104. For example, conversational practice assistant 110 may determine, based on information received from ear-wearable devices 102, one or more factors that indicate that it is appropriate to interact with user 104. In another example, conversational practice assistant 110 may use information obtained from a calendar of user 104 to determine that user 104 does not have anything scheduled (e.g., appointments, social events, etc.) that would interfere with an interaction with user 104. In another example, conversational practice assistant 110 may use a calendar of user 104 and/or ambient sound obtained by ear-wearable devices 102 to determine that there is an absence of social interaction. In yet another example, conversational practice assistant 110 may use physiological indicators of loneliness to determine whether use 104 would benefit from interactions with conversational practice assistant 110 and whether it would be appropriate to initiate a conversation with user 104. In addition, conversational practice assistant 110 may use environmental conditions consistent with user 104 not currently being active. In a further example, conversational practice assistant 110 may determine that user 104 has not interacted with any other individuals for a predetermined period of time, that user 104 is not currently active (e.g., not watching TV, working on a computer, etc.), that it may be appropriate to interact with user 104. In yet another example, conversational practice assistant 110 may determine whether an acoustic environment of user 104 meets one or more conditions (e.g., lack of ambient noise such as a TV) in order to determine whether it would be appropriate to initiate an interaction with user 104. Based on determining that it would be appropriate to initiate an interaction with user 104, conversational practice assistant 110 may provide a conversation initiator to user 104.

In some examples, conversational practice assistant 110 may use a loneliness metric in determining when to initiate interactions with user 104 and provide a conversation initiator. Conversational practice assistant 110 may calculate a metric representative of feelings of loneliness and isolation of user 104. Conversational practice assistant 110 may calculate the loneliness metric using trends of social interaction over a period of time and/or data regarding social interactions. For example, conversational practice assistant 110 may measure trends over time and predict periods of isolation of user 104. Conversational practice assistant 110 may store calculations of the loneliness metric in local computing system 106 for use in determining trends. In addition, conversational practice assistant 110 may store information in knowledge base 114 on the time and duration of conversations, and use such information in calculating the loneliness metric and measuring levels of social interaction by user 104. Further, conversational practice assistant 110 may use generative AI system 112 to generate information regarding loneliness and social interactions in an ontological format and store such ontological data in knowledge base 114 for use by generative AI system 112 or for use in generating prompts to generative AI system 112. Conversational practice assistant 110, as part of measuring trends, may use information from a calendar of user 104 as an input in calculating the loneliness metric. In some examples, conversational practice assistant 110 may track the behavior of user 104 to identify potential indicators of loneliness and trigger a conversation in response to identifying the indicators (e.g., provide a conversation initiator to user 104). In other words, conversational practice assistant 110 may trigger, based on the loneliness metric, the conversational practice assistant to initiate the interactive conversation. In some further examples, conversational practice assistant 110 may monitor the emotions of user 104. Further information on emotional monitoring may be found in US Patent Publication No. US20230016667, the entirety of which is incorporated herein.

Based on determining that it is appropriate to initiate an interaction with user 104, conversational practice assistant 110 may initiate an interaction with user 104. Conversational practice assistant 110 may initiate dialogue and other interactions with user 104 to assist user 104 with remembering various points of information. For example, conversational practice assistant 110 may, based on determining that user 104 has an upcoming medical appointment, may cause ear-wearable devices 102 to generate an auditory reminder of the upcoming medical appointment to user 104. In some examples, conversational practice assistant 110 may provide a conversation initiator that includes one or more reminders.

Conversational practice assistant 110 may monitor conversations with persons and aid user 104 in recalling information from the conversations. For example, ear-wearable devices 102 may determine that user 104 is conversing with another individual. Responsive to the determination, conversational practice assistant 102 may determine whether the individual is an individual that user 104 has indicated that they would prefer virtual assistant 110 to assist them in conversing with. For example, conversational practice assistant 102 may identify that the individual conversing with user 104 is an individual that has provided information regarding themselves to conversational practice assistant 102 and is known to user 104. Conversational practice assistant 102 monitors the conversation and extracts one or more pieces of information for later use. In an example, conversational practice assistant 102 determines that user 104 is conversing with an individual who is the son of user 104. During the conversation, conversational practice assistant 102 identifies the son of user 104 as saying “Your grandson Billy's birthday is in two weeks,” and records the information for later retrieval and use. Conversational practice assistant 102 may extract information with conversations such as points of information about friends and family of user 104 (e.g., birthdays, names, addresses, birthdays, jobs, pets, hobbies, favorite things, recent activities, points of information about extended family, and other topics of discussion). Conversational practice assistant 102 may also extract information such as small talk discussion points (e.g., weather, movies, music, meals, restaurants), medical concerns (e.g., how user 104 is feeling, accidents, recoveries, sleep, medicinal prompts), news headlines (e.g., major headlines, local news, topics of interest such as sports), and emotional topics (e.g., feelings, emotional support). In some examples, conversational practice assistant 102 may prompt generative AI system 112 to extract such information from transcripts of the conversation and/or other information associated with the conversation (e.g., data indicating emotional states of user 104 and/or other individuals at various times during the conversation). Conversational practice assistant 102 may store the extracted information in knowledge base 114.

In some examples, conversational practice assistant 110 may aid user 104 during conversations. For instance, during a conversation between user 104 and one or more other individuals, conversational practice assistant 110 may provide reminders and other information to user 104 to aid user 104 in engaging in conversation. As part of aiding a conversation, conversational practice assistant 110 may provide a conversation starter to user 104 via ear-wearable devices 102. Conversational practice assistant 100 may prompt generative AI system 112 to use information in knowledge base 114 to generate the reminders, conversation starters, conversation initiators, and/or other information. For example, conversational practice assistant 110 may provide a prompt such as a prompt to discuss an upcoming birthday, social events, family event, and prompting information. In some examples, conversational practice assistant 110 may provide prompts to generative AI system 112 to generate responses for use in enabling user 104 to practice based on the information. In addition, conversational practice assistant 110 may provide the prompts to generative AI system 112 in response to analyzing the ongoing conversation and determine, based on the context of the conversation, that providing a conversation initiator to user 104 may be appropriate. Conversational practice assistant 110 may generate conversation initiator based on information obtained by conversational practice assistant 110. In an example, conversational practice assistant 110 determines, during a conversation between user 104 and another individual, that it may be appropriate for user 104 to bring up information about a recent injury suffered by user 104's granddaughter that conversational practice assistant 110 has obtained during a previous conversation. Conversational practice assistant 110 generates a conversation initiator for user 104 to ask about the injury.

As noted above, conversational practice assistant 110 may use generative AI system 112 to process information received from user 104 and other individuals in addition to information obtained from conversations. In some examples, generative AI system 112 may include an AI-based chatbot that generates text as the basis for interactions with user 104 (e.g., using the chatbot to determine what to say in response to a user prompt). Conversational practice assistant 110 may provide information to generative AI system 112 retrieved from the memory of local computing system 106 and/or remote computing system (e.g., calendar events, data in knowledge base 114, etc.). In addition, conversational practice assistant 110 may provide data received from car-wearable devices 102 regarding an ongoing conversation to generative AI system 112 for processing. For example, conversational practice assistant 110 may provide audio data of a conversation to generative AI system 112. Conversational practice assistant 110 may process the audio data using a speech recognition model to extract text of the conversation from the audio data. Generative AI system 112 may process the extracted text using a language model to extract information from the text of the conversation (e.g., names, pieces of information such as upcoming events, changes to the health of individuals discussed during the conversation, etc.) and to generate ontological data from the extracted information.

Conversational practice assistant 110 may use generative AI system 112 to formulate interactions with user 104. Conversational practice assistant 110 may generate a prompt and provide the prompt to generative AI system 112. For example, conversational practice assistant 110 may generate a prompt that includes information about an ongoing conversation, a question posed by user 104, and other information. Generative AI system 112 receives the prompt and generates output data based on the received information included in the prompt. Conversational practice assistant 110 may process the output data into audio data for output by ear-wearable devices 102, such as a conversation initiator. Conversational practice assistant 110 may iteratively provide prompts to generative AI system 112 during a conversation with user 104. For example, conversational practice assistant 110 may provide a first prompt to generative AI system 112, receive first output data from generative AI system 112 based on the first prompt, output to ear-wearable devices 102 first audio data of or based on the first output data, receive a response of user 104, provide a second prompt to generated AI system 112 based on the response of user 104, receive second output data from generative AI system 112 in response to the second prompt, provide audio data of or based on the second output data to ear-wearable devices 102. Conversational practice assistant 110 may iteratively perform the process while conducting an interaction with user 104.

In some examples, conversational practice assistant 110 may simulate “practice” conversations with other individuals during interactions with user 104. User 104 may wish to practice a conversation to retain the conversation skills. In addition, user 104 may wish to practice a conversation to be prepared for a conversation with other individuals such as family members to make it easier for user 104 to engage with other individuals and/or to make it easier for the other individuals to engage with user 104. In some examples, conversational practice assistant 110 may enable user 104 to practice conversations to reduce the likelihood that other individuals disengage from interacting with user 104 and precipitating a downward trend. Conversational practice assistant 110 may reduce the likelihood of user 104 entering a downward trend or spiral where individuals reduce interactions with user 104, user 104 becomes less capable of communicating, and the individuals reduce their interactions further due to the increased difficulty of communicating with user 104. In an example, conversational practice assistant enables user 104 to practice conversations with individuals such as family associated with user 104 and improve familial engagement with those individuals.

As an example of practicing conversations, user 104 may use conversational practice assistant 110 to simulate conversations to replicate what a conversation would feel like to user 104. Conversational practice assistant 110 may initiate a practice conversation with user 104 in response to user 104 requesting a conversation. For example, user 104 may say to conversational practice assistant 110 “I'm going to meet my grandson soon, what should I talk about with him?” Conversational practice assistant 110 may identify (e.g., based on information in knowledge base 114) topics of conversation and initiate a conversation, such as using a conversation initiator, with user 104 that simulates a conversation between user 104 and their grandson. Conversational practice assistant 110 may perform practice conversations between conversational practice assistant 110 and user 104 that are based on one or more topics such as family concerns; small talk such as weather, movies, music, meals, restaurants; medical concerns such as how user 104 is feeling, accidents, recovery, sleep, medical prompts; news such as major and local headlines, sports, variety, business; and emotional topics such as how user 104 is feeling and providing support. In some examples, conversational practice assistant 110 may discuss the topics in a conversation with user 104 that is structured as a conversation between user 104 and conversational practice assistant 110 instead of a practice conversation. Conversational practice assistant 110 may also ask questions of user 104 and discuss both public information and private information (e.g., information obtained from individuals associated with user 104, information obtained during conversations). Conversational practice assistant 110 may simulate conversations with user 104 to encourage user 104 to retrieve information from their memory. In addition, conversational practice assistant 110 may simulate conversations to ameliorate loneliness and isolation felt by user 104, and to encourage familial engagement. Conversational practice assistant 110 may simulate a conversation between user 104 and another individual, where generative AI system 112 assumes the role of the other individual.

Conversational practice assistant 110 may ask questions of user 104 to encourage user 104 to retrieve information from their memory. Conversational practice assistant 110 may ask questions of user 104 after a predetermined period of time after user 104 has a conversation with another individual or may ask questions of user 104 in advance of a future conversation. Asking such questions may help user 104 refresh their memory or help to reinforce memories. Conversational practice assistant 110 may prompt generative AI system 112 to generate the questions based on information in knowledge base 114. In addition, conversational practice assistant 110 may retrieve information summarizing the conversation from local computing system 106. Conversational practice assistant 110 may retrieve information such as the summary of the conversation that is only stored on local computing system 106 for privacy reasons (e.g., to avoid storing personal information discussed during a conversation on an offsite computing system such as remote computing system 108). Conversational practice assistant 110 may provide the summary of the conversation in addition to a prompt to generate natural questions to generative AI system 112. Generative AI system 112 may generate one or more questions in natural language using the summary of the conversation. Responsive to the generation of the questions, conversational practice assistant 110 may ask user 104 one or more of the questions. For example, conversational practice assistant 110 may ask user 104 one or more questions that are based on the content of a past conversation or other information stored in knowledge base 114. In another example, conversational practice assistant 110 determines that user 104 has had a conversation with another individual that included discussing birthdays of children of user 104. Conversational practice assistant 110, after a predetermined period of time, may ask user 104 one or more questions based on information discussed during the conversation. In some examples, conversational practice assistant 110 may cause local computing system 106 to generate a user interface that includes one or more visual elements that indicate questions for user 104.

Conversational practice assistant 110 to improve and track memory performance of user 104. For example, conversational practice assistant 110 may track how much information user 104 retains after conversation. For instance, conversational practice assistant 110 may add information to knowledge base 114 regarding the answers of user 104. In another example, conversational practice assistant 110 determines how many answers from user 104 are correct and stores information regarding the answers from user 104. Conversational practice assistant 110 uses the information to track the ability of user 104 to retain information over time. In addition, conversational practice assistant 110 may ask questions to obtain updates to information retained by conversational practice assistant 110.

In some examples, conversational practice assistant 110 asks questions of user 104 to develop and expand knowledge base 114. Conversational practice assistant 110 may ask questions outside of any particular conversation to develop and expand knowledge base 114 of conversational practice assistant 110. In an example, conversational practice assistant 110 receives information indicating that an aunt of user 104 has five grandchildren (e.g., an individual mentions the grandchildren during a conversation with user 104, a family member provides information regarding the aunt and her grandchildren via a webpage, etc.). This information may be stored in knowledge base 114. Conversational practice assistant 110 may generate a prompt regarding the aunt and her grandchildren and provide the prompt to generative AI system 112. Generative AI system 112 generates one or more questions regarding the aunt and grandchildren in response to the prompt and provides the questions to conversational practice assistant 110. Based on the generation of the questions, conversational practice assistant 110 asks user 104 the questions to obtain further information regarding the aunt and grandchildren. Conversational practice assistant 110 may use answers to the questions to expand knowledge base 114.

Conversational practice assistant 110 may use generative AI system 112 to generate ontological data associated with user 104. Such ontological data 114 may be stored in knowledge base 114. Conversational practice assistant 110 may cause generative AI system 112 to generate and maintain the ontological data associated with user 104 to organize information regarding user 104 and individuals associated with user 104. In an example, generative AI system 112 generates the ontological data to map relationships between user 104 and individuals such as family members associated with user 104. Conversational practice assistant 110 may store the ontological data generated by generative AI system 112 (e.g., in knowledge base 114) and may use the ontological data in generating prompts for generative AI system 112. In some examples, generative AI system 112 may generate the ontological data in a computer-readable format such as Web Ontology Language (OWL) or another format. Further information regarding OWL may be found at OWL 2 Web Ontology Language Document Overview (Second Edition), W3C, https://www.w3.org/TR/2012/REC-ow12-overview-20121211/#Documentation_Roadmap.

Conversational practice assistant 110 may obtain information from user 104 and process the information. Conversational practice assistant 110 may obtain information from user 104 from ear-wearable devices 102 and/or local computing system 106. For example, conversational practice assistant 110 may obtain information from ear-wearable devices that is audio spoken by user 104. Conversational practice assistant 110 may obtain information from user 104 and verify whether the information obtained from user 104 is correct. Conversational practice assistant 104 may verify the correctness of the information using the information obtained from one or more individuals associated with user 104. In an example, conversational practice assistant 110 asks a question regarding the birthday of a relative of user 104. Conversational practice assistant 110 receives a response from user 104 and extracts data from the response by user 104.

Conversational practice assistant 110 may compare the data to the information in knowledge base 114 (e.g., information retained by conversational practice assistant 110) to verify the correctness of the response by user 104. For example, conversational practice assistant 110 may compare information received from user 104 to information stored in knowledge base 114 to verify the accuracy of the information. In some examples, conversational practice assistant 110 may verify the correctness of the information received from user 104 via a companion application executed by a computing device associated with another individual such as a family member of user 104. For example, conversational practice assistant 110 may provide an indication to the companion application of an answer by user 104 to a question. The companion application may provide an option for a user to click “yes” or “no” and to submit a correction or replacement fact. In addition, conversational practice assistant 110 may query, via the companion application, individuals for specific pieces of information.

In some examples, conversational practice assistant 110 may update knowledge base 114 (e.g., ontological data in knowledge base 114) to include information reported by user 104 and information reported by other individuals. Conversational practice assistant 110 may keep separate and maintain indications of which information was reported by user 104 and which information was reported by other individuals. In an example, conversational practice assistant 110 receives information from user 104 indicating that Sally broke her arm. In addition, conversational practice assistant 110 receives information from other individuals via a webpage indicating that it was actually Billy who broke their arm. Conversational practice assistant 110 stores information in knowledge base 114 regarding both Sally and Billy but includes an indication that the information about Sally may be incorrect. In some examples, conversational practice assistant 110 may use the information obtained from the webpage and companion app to learn and train one or more models of conversational practice assistant 110. For example, conversational practice assistant 110 may use information about individuals known by user 104 to train the one or more models.

Conversational practice assistant 110 may enable individuals such as family members to determine whether user 104 is correctly remembering information. Conversational practice assistant 110 may enable family members to check whether user 104 has correctly remembered information discussed with user 104. For example, a family member may tell user 104 in a conversation that Billy broke his arm. Conversational practice assistant 110 may store information in knowledge base 114 that Billy broke his arm. Later, conversational practice assistant 110 may ask user 104 who broke their arm and user 104 responds that Sally broke her arm. Conversational practice assistant 110 may provide an indication of the incorrect response to the family member. In addition, conversational practice assistant 110 may correct user 104 and indicate that Billy broke his arm. Conversational practice assistant 110 may store information in knowledge base 114 about the response of user 104. Conversational practice assistant 110 may use generative AI system 112 to formulate a natural language text for this interaction.

Conversational practice assistant 110 may retain information received from user 104 and other individuals in addition to information regarding prior interactions with user 104 to build knowledge base 114 so that knowledge base 114 is tailored to interacting with user 104. For example, conversational practice assistant 110 may store information regarding prior interactions with user 104 such as metrics of the interaction (e.g., whether user 104 understood the interaction, whether user 104 responded positively or negatively to the interaction, whether user 104 indicated that the interaction was helpful, whether user 104 has repeatedly requested similar interactions, etc.), topics of the interaction, and purpose of the interaction (e.g., user 104 asking for particular pieces of information from conversational practice assistant 110, user 104 discussing a particular set of topics with an individual, etc.). Conversational practice assistant 110 may use the information of knowledge base 114 to tailor interactions with user 104 and to generate prompts for generative AI system 112, as well as provide conversation initiators to user 104.

Conversational practice assistant 110 may ask user 104 questions to track whether user 104 remembers different pieces of information. Conversational practice assistant 110, in response to receiving an incorrect answer from user 104, may alert a caregiver that an incorrect answer was received. In addition, conversational practice assistant 110 may generate a response to the incorrect answer that corrects user 104 and cause car-wearable devices 102 to generate audio of the response. In an example, conversational practice assistant 110 receives an incorrect answer from user 104 in response to a question posed by conversational practice assistant 110. Conversational practice assistant 110, based on the incorrect response to the question, generates a response that includes a correction to the incorrect information. Conversational practice assistant 110 causes car-wearable devices 102 to generate audio based on the response that includes the correction. Conversational practice assistant 110 may tailor the response that includes the correction to avoid upsetting user 104 and to gently correct user 104. In some examples, conversational practice assistant 110 may alert a caregiver that user 104 has provided an incorrect response to a question.

Conversational practice assistant 110 may perform a post-conversation review with user 104 after a conversation between user 104 and another individual. Conversational practice assistant 110 may perform a conversation review with user 104 to review information discussed during the previous conversation and to reinforce the conversation in the mind of user 104. For example, conversational practice assistant 110 may prompt generative AI system 112 to generate ontological data associated with the conversation and store the resulting ontological data in knowledge base 114. The ontological data may include data representing the semantic content of the conversation, information about emotional states of participants of the conversation, and so on. Conversational practice assistant 110 may prompt generative AI system 112 to generate natural language text based on the ontological data associated with the conversation. An example of natural language text generated by generative AI system 112 may ask user 104 to identify one or more topics discussed in the conversation. Other examples of natural language text generated by generative AI system 112 may ask user 104 to describe something they learned in the conversation, how user 104 felt during the conversation, and other questions regarding the conversation.

As noted above, the ontological data associated with a conversation may include information about the emotional states of participants of the participants of the conversation. Ear-wearable devices 102 may include sensors that generate signals that can be used help to determine the emotional state of user 104 during a conversation. For example, ear-wearable devices 102 may include heart rate sensors, skin galvanic response sensors, sensors that measure blood pressure, sensors that measure eye movement, and so on. Conversational practice assistant 110 or another system may analyze such signals, along with audio signals, to determine emotional states of user 104 at various points in the conversation. For example, such a system may determine that user 104 was nervous, angry, relaxed, or happy at various points in the conversation. Sensors in ear-wearable devices 102 may also be well-positioned to detect laughter of user 104 (e.g., via IMUs in combination with audio data). Such sensors in ear-wearable devices 102 may be especially well suited for determining emotional content of conversations because the surface of the skin of the car is relatively thin and therefore allows easier detection of certain biological signals associated with emotion. Additionally, laughter is commonly associated with head movement. Head tilt and body posture can also be indicative of emotional state. For example, a downward tilted head and a slouched posture can be associated with sadness. IMUs or other sensors in ear-wearable devices 102 may be well suited to detecting head tilt and body posture. Additionally, direction of eye gaze can be indicative emotional state. Ear-wearable devices 102 may use eye movement related eardrum oscillations to determine direction of eye gaze.

The emotional state of user 104 at various points in conversations can be used for various purposes. For example, a system can evaluate, based on the emotional state of user 104 at various points in the conversation, whether the user has appropriate emotional responses to information, e.g., laughing at inappropriate times. Conversational practice assistant 110 may also use the emotional state of user 104 to determine topics of conversation that user 104 would prefer to avoid. In some examples, conversational practice assistant 110 may use the emotional states of user 104 to detect signs of depression in conversations.

In some examples, conversational practice assistant 110 may cause generative AI system 112 to generate ontological information regarding individuals associated with user 104, such as points of information regarding the individuals (e.g., relationships, mannerisms, what the individuals discussed during different conversations, etc.). Conversational practice assistant 110 may use the ontological information to formulate questions to ask user 104 and while providing conversation initiators. In addition, conversational practice assistant 110 may provide the ontological information along with a prompt for a question or other type of interaction to generative AI system 112. Generative AI system 112 processes the ontological information and prompt and generates natural language text to be provided to user 104. In addition, conversational practice assistant 110 may provide a prompt and information regarding a conversation to generative AI system 112 to request generative AI system 112 make a natural language summary of the conversation. In an example, conversational practice assistant 110, based on determining that a conversation has ended between user 104 and a group of individuals, initiates a conversation with user 104 by providing a conversation initiator. Conversational practice assistant 110 uses generative AI system 112 to generate natural language for use in conversing with user 104 and as part of the conversation initiator. Conversational practice assistant 110 initiates a conversation to discuss the previous conversation and to review information discussed during the previous conversation.

Conversational practice assistant 110 may provide one or more indications to user 104 and other individuals that conversational practice assistant 110 is monitoring a conversation or is participating in a conversation. For example, conversational practice assistant 110 may cause ear-wearable devices to illuminate an indicator LED or other light to indicate that conversational practice assistant 110 is monitoring or otherwise participating in a conversation. In another example, user 104 is using ear-wearable devices 102 to take a phone call via local computing system 106 while conversational practice assistant 110 is monitoring the phone call. Conversational practice assistant 110 may cause ear-wearable devices 102 and/or local computing system 106 to inject audio into user 104's end of the phone call to indicate that the phone call may be monitored or recorded by conversational practice assistant 110.

Conversational practice assistant 110 may provide information to user 104 as part of an information provider mode. Conversational practice assistant 110 may enter into an information provider mode in response to a prompt from user 104 (e.g., pressing a button, indicating via local computing system 106, speaking a request to enable the mode, etc.). Conversational practice assistant 110, while in the information provider mode, may provide one or more points of information to user 104. In an example, while in the information provider mode conversational practice assistant 110 receives a request from user 104 to provide information regarding upcoming appointments. Conversational practice assistant 110, responsive to the request, retrieves the information and communicates the information to user 104. In some examples, conversational practice assistant 110 may provide information to user 104 without user 104 requesting the information. For example, conversational practice assistant 110 may provide a summary of information such as the weather, events scheduled for a particular day, and a brief news summary.

The use of ear-wearable devices 102 as an interface for interacting with conversational practice assistant 110 may have several benefits. For example, users tend to wear ear-wearable devices 102 almost all the time during their waking hours. This allows user 104 to have more opportunities to interact with conversational practice assistant 110 during most of their waking hours. Moreover, because users tend to wear ear-wearable devices 102 for prolonged periods, interacting with conversational practice assistant 110 via ear-wearable devices 102 may be a more seamless experience for users than trying to find a separate device, such as a smartphone or smart speaker. Additionally, because users tend to wear ear-wearable devices 102 for prolonged periods of time, car-wearable devices 102 may be able to capture information that gives a more complete understanding of the user's activities, health, and personal interactions. Such information may include speech information, environmental information, health information, acoustic information, and so on.

Additionally, ear-wearable devices 102 are uniquely capable of detecting and processing the speech of users of ear-wearable devices 102. For instance, because car-wearable devices 102 are placed in or near the cars of user 104, on either side of the vocal passage of user 104, ear-wearable devices 102 are well situated to distinguish the voice of user 104 from the voices of other people. Additionally, ear-wearable devices 102, unlike other types of devices, may be tuned to overcome the specific hearing difficulties of user 104. This may enhance the ability of user 104 to naturally hear and understand conversational practice assistant 110.

Furthermore, ear-wearable devices 102 may be uniquely situated to collect relevant data about user 104 that may enhance the ability of conversational practice assistant 110 to interact with user 104. For instance, ear-wearable devices 102 may be well-situated to detect various health metrics of user 104, such as heart rate, body temperature, respiration rate, activity levels, detection of falls, galvanic skin response, and so on. Conversational practice assistant 110 may use or collect such data. In some examples, ear-wearable devices 102 may collect data (e.g., audio data, health data, activity data, and/or other types of data) throughout the time user 104 is wearing car-wearable devices 102. In some examples, ear-wearable devices 102 may only collect data during specific times, in response to specific events, or data collection may be otherwise more limited in terms of times and situations.

As part of their role in compensating for hearing difficulties of users, ear-wearable devices 102 may perform various signal processing activities to improve the intelligibility of the audio data generated by microphones (e.g., microphones of ear-wearable devices 102, remote microphones, etc.). For example, ear-wearable devices 102 may perform signal processing to suppress wind noise, suppress background noise, perform directional beam processing to enhance sounds from specific directions, enhance human speech, and so on. Ear-wearable devices 102 may perform one or more of these same signal processing activities to preprocess the audio data used as a basis for interacting with conversational practice assistant 110. Thus, it may be unnecessary for such signal processing activities to be replicated at a separate computing system, which may reduce the overall complexity and cost of implementing conversational practice assistant 110. Additionally, because ear-wearable devices 102 may include processing circuitry specifically designed for such signal processing (because such specifically designed processing circuitry may be needed to support the hearing assistance role of ear-wearable devices 102), the signal processing may be faster than if implemented on more generic processors. Furthermore, the processed audio data may include less data than unprocessed data (e.g., due to filtering out background noise), which may conserve bandwidth and prolong battery life of ear-wearable devices 102 (and, in some instances, local computing system 106).

As mentioned briefly above, conversational practice assistant 110 may provide reminders to user 104 and help user 104 accomplish their daily activities. For example, conversational practice assistant 110 may learn and track a daily routine of user 104 based on information generated by ear-wearable devices 102 (and, in some examples, other sources). Parts of the daily routine may include eating, using the bathroom, showering/bathing, taking medications, exercising, watching television, and so on. Conversational practice assistant 110 may generate reminders if user 104 did not perform a specific task (e.g., taking medication, showering/bathing, eating, etc.). In some examples, because conversational practice assistant 110 may learn and track the daily routine of user 104, user 104 may ask conversational practice assistant 110 whether user 104 performed an activity. For instance, user 104 may ask conversational practice assistant 110 whether user 104 took their pills this morning, and conversational practice assistant 110 may provide a vocal response, such as “Yes, I heard you taking your pills this morning.” In some examples, conversational practice assistant 110 can track the remaining quantity of medication available to user 104 and remind user 104 to refill a prescription of the medication or may automatically request a refill of the prescription. Conversational practice assistant 110 may track the remaining quantity of medication based on spoken information provided to conversational practice assistant 110, a priori knowledge of medication dosage and provided quantities, or other sources. For instance, conversational practice assistant 110 may provide a vocal indication such as “I heard you saying you need to refill your prescription as you only had 2 pills left.”

In some examples, conversational practice assistant 110 has access to a calendar and may use the calendar to provide reminders to user 104. For example, conversational practice assistant 110 may remind user 104 about an upcoming appointment, social engagement, airtime of a favorite television show, mealtime, or other event. Conversational practice assistant 110 may generate conversion initiators based on the calendar of user 104. In some examples, the calendar may be shared among user 104 and other individuals, such as family members, community members, and caregivers. Thus, people other than user 104 may be able to add events to the calendar. Reminders about events may help users, especially those with memory impairments, live better lives and experience less frustration. In some examples, conversational practice assistant 110 may add events to the calendar based on audio data (which may or may not be explicitly directed to conversational practice assistant 110) generated by ear-wearable devices 102. For example, conversational practice assistant 110 may receive audio data indicating that user 104 has a doctor appointment at 3 pm on November 2. Accordingly, in this example, conversational practice assistant 110 may provide a reminder to user 104 about the doctor appointment at an appropriate time before the appointment.

In some examples, conversational practice assistant 110 may receive audio data generated by ear-wearable devices 102 representing the voices of people with whom user 104 is interacting. Based on audio data generated by ear-wearable devices 102, conversational practice assistant 110 may identify a person with whom user 104 is interacting. Conversational practice assistant 110 may learn and store information about the person (e.g., their relationship with user 104, content of interactions between the person and user 104, the person's name, the person's interests, etc.). Conversational practice assistant 110 may learn the information based on audio data generated by car-wearable devices 102 and/or other sources. Conversational practice assistant 110 may use the information about the person with whom user 104 is interacting (or a person with whom user 104 may soon interact) to provide reminders to user 104 about the person. For instance, conversational practice assistant 110 may remind user 104 about the person's name, when user 104 last interacted with the person, what the person and user 104 have previously discussed, and provide other information about the person to user 104. Such reminders may be particularly helpful if user 104 has memory issues, face-blindness, or interacts with a large number of people.

As mentioned above, conversational practice assistant 110 may learn information about other people based on audio data generated by ear-wearable devices 102 and/or other sources. For instance, a user interface may be provided (e.g., by local computing system 106 and/or remote computing system 108) that enables people to provide information about themselves. In some examples, the user interface may allow people to provide voice samples. This may enhance the ability of conversational practice assistant 110 to provide information about people to user 104.

In some examples, user 104 may use conversational practice assistant 110 to control various aspects of ear-wearable devices 102. For example, user 104 may issue spoken commands to conversational practice assistant 110 to change the volume (e.g., global gain, shift gain profile against a range of frequencies, etc.) of ear-wearable devices 102 up or down. In some examples, user 104 may issue spoken commands to conversational practice assistant 110 to change a profile of ear-wearable devices 102 to restaurant mode, music listening mode, quiet mode, conversation mode, and so on. In some examples, user 104 may issue spoken commands to conversational practice assistant 110 to activate or deactivate features of ear-wearable devices 102, such as tinnitus masking, directional sound processing, noise suppression, remote microphones, and so on. In some examples, conversational practice assistant 110 may accept input to control aspects of ear-wearable devices 102 from sources other than audio data generated by car-wearable devices 102, such as a user interface of a computing device used by user 104, a hearing professional, a caregiver, or another type of authorized person.

Conversational practice assistant 110 may allow user 104 to control aspects of ear-wearable devices 102 using a conversational style. For instance, user 104 may tell conversational practice assistant 110 that the running water is too loud and conversational practice assistant 110 may determine an appropriate adjustment to one or more aspects of ear-wearable devices 102 to address the user's complaint. In some examples, user 104 may ask open ended questions to conversational practice assistant 110, to which conversational practice assistant 110 may make suggestions to change one or more aspects of ear-wearable devices 102 or automatically make changes to one or more aspects of ear-wearable devices 102. For example, conversational practice assistant 110 may receive and respond to an open-ended request or question regarding improving sound quality, e.g., “how should I improve my sound quality?” In responding to a request to improve sound quality, conversational practice assistant 110 may take into consideration various factors, such as environmental factors (e.g., noise levels), user history, user listening intent (e.g., comfort vs. clarity), and/or other factors. In other words, conversational practice assistant 110 may determine, based on such factors, one or more actions to adjust one or more aspects of ear-wearable devices 102. Conversational practice assistant 110 may determine environmental factors based on audio data generated by car-wearable devices 102, which a computing system (e.g., ear-wearable devices 102, local computing system 106 or remote computing system 108) may store in a rolling buffer. Conversational practice assistant 110 may utilize a history of adjustments that user 104 has made in the past in different acoustic situations as a way to adjust aspects of car-wearable devices 102.

In some examples, conversational practice assistant 110 may suggest and/or make adjustments to aspects of ear-wearable devices 102 based on the person or type of person with whom user 104 is talking. For instance, conversational practice assistant 110 may determine that the make adjustments to one or more aspects of ear-wearable devices 102 based on whether user 104 is speaking with a man, woman, or child, e.g., to improve speech intelligibility for user 104. In some examples, conversational practice assistant 110 may detect that the volume level of the person with whom user 104 is speaking is too low and may suggest increasing (or may automatically increase) gain.

Conversational practice assistant 110 may store a history of adjustments, requests for adjustments, and other factors. A hearing professional may use this history when determining how to manually adjust aspects of ear-wearable devices 102.

In some examples, conversational practice assistant 110 may use a trained machine learning (ML) model to predict adjustments that a hearing professional would make based on the user's statements and actions. The trained ML model may be trained based on data (e.g., listening environments, feedback from user 104, feedback from a population of users).

In some examples, when conversational practice assistant 110 receives a request to adjust one or more aspects of ear-wearable devices 102, conversational practice assistant 110 may provide an audible response to user 104, e.g., via one or more of car-wearable devices 102, via local computing system 106 (e.g., a smartphone of user 104). The audible response may let user 104 know that conversational practice assistant 110 has made a change to the one or more aspects of ear-wearable devices 102. For instance, conversational practice assistant 110 may cause ear-wearable devices 102 to output a verbal response such as “Okay, let's try this” or a musical response (e.g., a “ta-da!” sound). In some examples, conversational practice assistant 110 may cause local computing system 106 (e.g., a smartphone of user 104) to provide a graphical or haptic indication that conversational practice assistant 110 has made a change to the one or more aspects of ear-wearable devices 102.

In some examples, conversational practice assistant 110 may perform an auto-fitting process to adjust aspects (e.g., global gain levels, frequency-specific gain levels, etc.) of ear-wearable devices 102 in response to a request from user 104 or other event. The auto-fitting process may involve ear-wearable devices 102 outputting specific tones and receiving responses from user 104 about the user's perception of the tones. Conversational practice assistant 110 may determine how to adjust aspects of car-wearable devices 102 based on the responses from user 104. Conversational practice assistant 110 may use a set of predefined rules based on the user's responses to determine how to adjust the aspects of ear-wearable devices 102. In some examples, conversational practice assistant 110 may guide user 104 step-by-step through a self-fit process that helps user 104 adjust aspects of ear-wearable devices 102 to the personal needs and preferences of user 104.

In some examples, conversational practice assistant 110 may interact with user 104 to perform telehealth activities. For example, conversational practice assistant 110 may interact with user 104 to perform routine (e.g., daily, weekly, etc.) health checks. In this example, conversational practice assistant 110 may inquire how user 104 is feeling, inquire about specific symptoms, inquire about aspects of the mental and/or social health of user 104, and so on. Conversational practice assistant 110 may aggregate the responses of user 104 to the health checks to form a longer term understanding of the physical and/or mental well-being of user 104.

In some examples, conversational practice assistant 110 may detect changes in one or more health indicators of user 104 and respond accordingly. For instance, conversational practice assistant 110 may detect changes in the speech of user 104 that may be indicative of a stroke, cognitive decline (e.g., pausing more, phrases/sounds indicative of memory recall problems, declining vocabulary set, etc.), agitation, and so on. In some examples, conversational practice assistant 110 may detect changes to the gait of user 104 based on motion signals generated by motion sensors of ear-wearable devices 102. In other examples, conversational practice assistant 110 may detect physiological indicators that are consistent with loneliness or social isolation.

In some examples, user 104 may use conversational practice assistant 110 without ear-wearable devices 102. In some such examples, conversational practice assistant 110 may simulate for user 104 what a sound would be like with hearing loss, or with a hearing aid.

In some examples, conversational practice assistant 110 may receive and respond to questions from user 104 regarding ear-wearable devices 102. For instance, conversational practice assistant 110 may receive and respond to help requests from user 104. Other types of questions may include questions about ear-wearable devices 102 themselves, such as the type of battery, model information for ear-wearable devices 102, battery levels of ear-wearable devices 102, ear-wearable devices 102 usage times, how ear-wearable devices 102 work, how to use features of ear-wearable devices 102, troubleshoot problems with ear-wearable devices 102, and so on.

Conversational practice assistant 110 may use generative AI techniques to generate responses to user 104. For instance, conversational practice assistant 110 may use a generative AI system, such as generative AI system 112, to generate responses. Generative AI system 112 may include a large language model (LLM). Examples of LLMs include ChatGPT by OpenAI, LlaMA by Meta Platforms, Inc. PaLM and Gemini from Google, Inc., and so on. Thus, in some such examples, conversational practice assistant 110 may present information (e.g., text of a request of user 104, data regarding environmental acoustic factors, user history, etc.) as a prompt to the LLM. The LLM may then generate a output (e.g., a textual output). Depending on the prompt, the LLM may generate different types of responses. For example, in response to a request from user 104 related to changing one or more aspects of ear-wearable devices 102, generative AI system 112 may output a series of actions or steps, such as actions to adjust one or more aspects of ear-wearable devices 102. In another example, conversational practice assistant may generate a prompt as including a request for information about a conversation partner that may cause the LLM to generate a query to retrieve information about the conversation partner from a database and use the retrieved information as another prompt to cause the LLM to format the retrieved information in a conversational style.

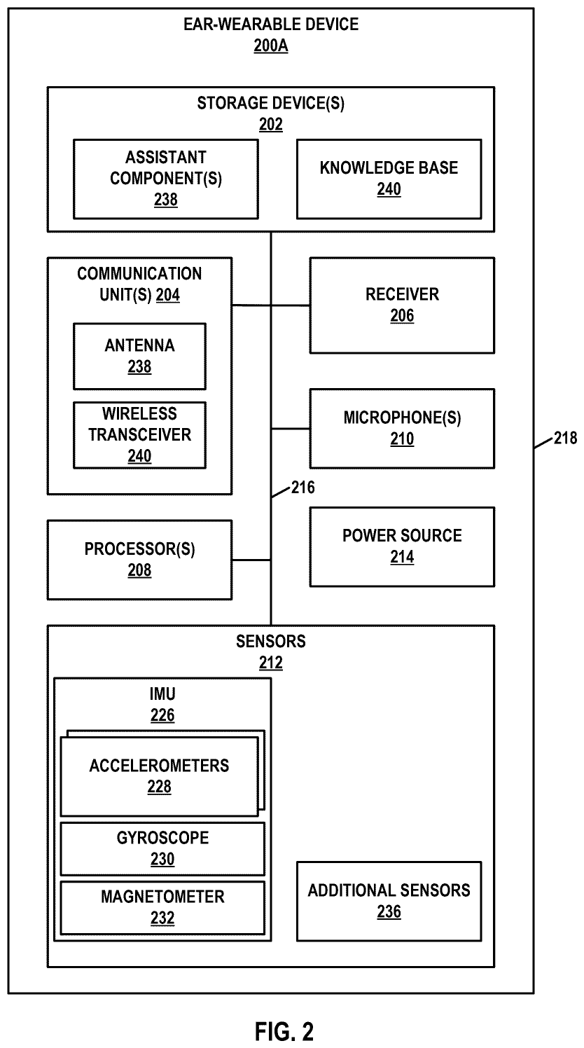

FIG. 2 is a block diagram illustrating example components of ear-wearable device 200A, in accordance with one or more aspects of this disclosure. Ear-wearable device 102B as shown in FIG. 1 may include the same or similar components of ear-wearable device 200A shown in the example of FIG. 2. Thus, the discussion of FIG. 2 may apply with respect to ear-wearable device 102B. In the example of FIG. 2, ear-wearable device 200A includes one or more storage devices 202, one or more communication units 204, a receiver 206, one or more processors 208, one or more microphones 210, a set of sensors 212, a power source 214, and one or more communication channels 216. Communication channels 216 provide communication between storage devices 202, communication unit(s) 204, receiver 206, processor(s) 208, microphone(s) 210, and sensors 212. Components 202, 204, 206, 208, 210, 212, and 216 may draw electrical power from power source 214.

In the example of FIG. 2, each of components 202, 204, 206, 208, 210, 212, 214, and 216 are contained within a single housing 218. For instance, in examples where ear-wearable device 200A is a BTE device, each of components 202, 204, 206, 208, 210, 212, 214, and 216 may be contained within a behind-the-ear housing. In examples where ear-wearable device 200A is an ITE, ITC, CIC, or IIC device, each of components 202, 204, 206, 208, 210, 212, 214, and 216 may be contained within an in-ear housing. However, in other examples of this disclosure, components 202, 204, 206, 208, 210, 212, 214, and 216 are distributed among two or more housings. For instance, in an example where ear-wearable device 200A is a RIC device, receiver 206, one or more of microphones 210, and one or more of sensors 212 may be included in an in-ear housing separate from a behind-the-ear housing that contains the remaining components of ear-wearable device 200A. In such examples, a RIC cable may connect the two housings.

Furthermore, in the example of FIG. 2, sensors 212 include an inertial measurement unit (IMU) 226 that is configured to generate data regarding the motion of ear-wearable device 200A. IMU 226 may include a set of sensors. For instance, in the example of FIG. 2, IMU 226 includes one or more accelerometers 228, a gyroscope 230, a magnetometer 232, combinations thereof, and/or other sensors for determining the motion of ear-wearable device 200A. Furthermore, in the example of FIG. 2, ear-wearable device 200A may include one or more additional sensors 236. Additional sensors 236 may include a photoplethysmography (PPG) sensor, blood oximetry sensors, blood pressure sensors, electrocardiogra (EKG) sensors, body temperature sensors, electroencephalography (EEG) sensors, environmental temperature sensors, environmental pressure sensors, environmental humidity sensors, skin galvanic response sensors, and/or other types of sensors. In other examples, ear-wearable device 200A and sensors 212 may include more, fewer, or different components.

Storage devices 202 may store data. Storage devices 202 may include volatile memory and may therefore not retain stored contents if powered off. Examples of volatile memories may include random access memories (RAM), dynamic random access memories (DRAM), static random access memories (SRAM), and other forms of volatile memories known in the art. Storage devices 202 may include non-volatile memory for long-term storage of information and may retain information after power on/off cycles. Examples of non-volatile memory may include flash memories or forms of electrically programmable memories (EPROM) or electrically erasable and programmable (EEPROM) memories.

Storage devices 202 include assistant components 238. Assistant components 238 may include one or more software components that provide functionality of a conversational practice assistant such as conversational practice assistant 110 as illustrated in FIG. 1. Processors 208 may execute instructions of assistant components 238 as part of providing the conversational practice assistant. For example, processors 208 may execute instructions of assistant components 238 and retrieve user-specific data from knowledge base 240.

Storage devices 202 include knowledge base 240. Knowledge base 240 may be similar to knowledge base 114 as illustrated in FIG. 1 and provide similar functionality. For example, ear-wearable device 200 may store information regarding a user that is received via communication unit(s) 204 from another computing device.

Communication unit(s) 204 may enable ear-wearable device 200A to send data to and receive data from one or more other devices, such as a device of local computing system 106 (FIG. 1), another ear-wearable device (e.g., ear-wearable device 102B), an accessory device, a mobile device, or other types of devices. Communication unit(s) 204 may enable ear-wearable device 200A to use wireless or non-wireless communication technologies. For instance, communication unit(s) 204 enable ear-wearable device 200A to communicate using one or more of various types of wireless technology, such as a BLUETOOTH™ technology, 3G, 4G, 4G LTE, 5G, ZigBee, WI-FI™, Near-Field Magnetic Induction (NFMI), ultrasonic communication, infrared (IR) communication, or another wireless communication technology. In some examples, communication unit(s) 204 may enable ear-wearable device 200A to communicate using a cable-based technology, such as a Universal Serial Bus (USB) technology.

Receiver 206 includes one or more speakers for generating auditory stimuli, such as audible sound, vibration, or cochlear stimulation signals. Receiver 206 may include one or more speakers. The speakers of receiver 206 may generate auditory stimuli that include a range of frequencies. In some examples, the speakers of receiver 206 include “woofers” and/or “tweeters” that provide additional frequency range.

Processor(s) 208 include processing circuits configured to perform various processing activities. Processor(s) 208 may be similar to processors 116 as illustrated in FIG. 1 and provide similar functionality. Processor(s) 208 may process signals generated by microphone(s) 210 to enhance, amplify, or cancel-out particular channels within the incoming sound. Processor(s) 208 may then cause receiver 206 to generate auditory stimuli based on the processed signals. In some examples, processor(s) 208 include one or more digital signal processors (DSPs). In some examples, processor(s) 208 may cause communication unit(s) 204 to transmit one or more of various types of data. For example, processor(s) 208 may cause communication unit(s) 204 to transmit data to computing system 106. Furthermore, communication unit(s) 204 may receive audio data from local computing system 106 and processor(s) 208 may cause receiver 206 to output auditory stimuli based on the audio data. In the example of FIG. 2, processor(s) 208 may include processors such as processors 112A as illustrated in FIG. 1.

Microphone(s) 210 detect incoming sound and generate one or more electrical signals (e.g., an analog or digital electrical signal) representing the incoming sound. In some examples, microphone(s) 210 include directional and/or omnidirectional microphones.

In accordance with one or more techniques of this disclosure, communication unit(s) 204 may send audio data (and, in some examples other data, such as sensor data) to local computing system 106 for eventual processing by conversational practice assistant 110. In some examples, processors 208 may process audio data generated by microphone(s) 210 prior to communication unit(s) 204 transmitting the audio data. As previously discussed, preprocessing the audio data in this way may be efficient because ear-wearable device 200 may already be equipped for such audio processing. Additionally, communication unit(s) 204 may receive an output from conversational practice assistant 110 (e.g., audio data or other types of data from local computing system 106). Processor(s) 208 may convert the output into an audio signal that receiver 206 may convert into auditory stimuli.

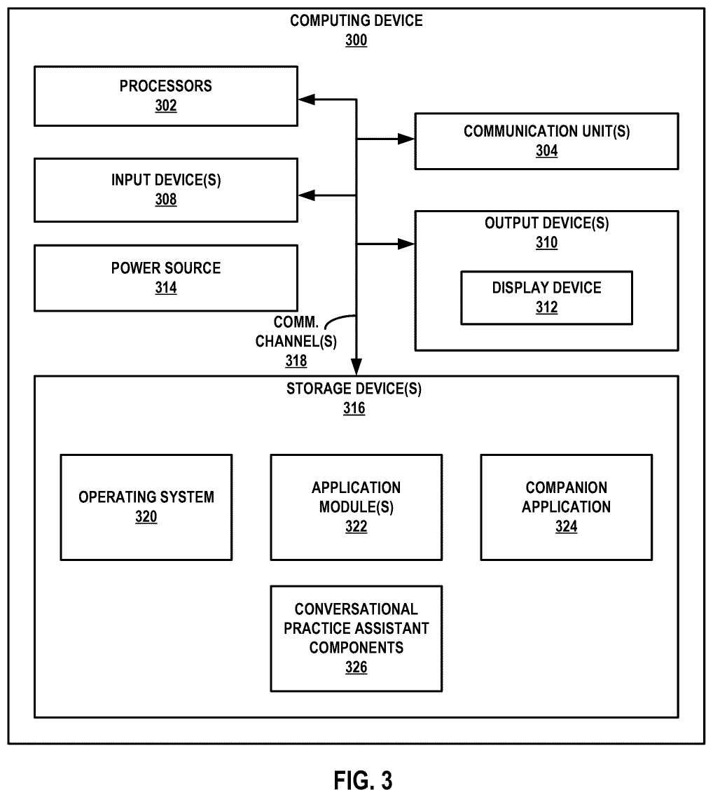

FIG. 3 is a block diagram illustrating example components of a computing device 300, in accordance with one or more aspects of this disclosure. FIG. 3 illustrates only one example of computing device 300, and many other example configurations of computing device 300 exist. Computing device 300 may be a computing device in local computing system 106 or remote computing system 108 as illustrated in FIG. 1.

As shown in the example of FIG. 3, computing device 300 includes one or more processors 302, one or more communication units 304, one or more input devices 308, one or more output device(s) 310, a display screen 312, a power source 314, one or more storage device(s) 316, and one or more communication channels 318. Computing device 300 may include other components. For example, computing device 300 may include physical buttons, microphones, speakers, communication ports, and so on. Communication channel(s) 318 may interconnect each of components 302, 304, 308, 310, 312, and 316 for inter-component communications (physically, communicatively, and/or operatively). In some examples, communication channel(s) 318 may include a system bus, a network connection, an inter-process communication data structure, or any other method for communicating data. Power source 314 may provide electrical energy to components 302, 304, 308, 310, 312 and 316.

Storage device(s) 316 may store information required for use during operation of computing device 300. In some examples, storage device(s) 316 have the primary purpose of being a short-term and not a long-term computer-readable storage medium. Storage device(s) 316 may include volatile memory and may therefore not retain stored contents if powered off. In some examples, storage device(s) 316 includes non-volatile memory that is configured for long-term storage of information and for retaining information after power on/off cycles. In some examples, processor(s) 302 of computing device 300 may read and execute instructions stored by storage device(s) 316.

Computing device 300 may include one or more input devices 308 that computing device 300 uses to receive user input. Examples of user input include tactile, audio, and video user input. Input device(s) 308 may include presence-sensitive screens, touch-sensitive screens, mice, keyboards, voice responsive systems, microphones, motion sensors capable of detecting gestures, or other types of devices for detecting input from a human or machine.

Communication unit(s) 304 may enable computing device 300 to send data to and receive data from one or more other computing devices (e.g., via a communication network, such as a local area network or the Internet). For instance, communication unit(s) 304 may be configured to receive data sent by ear-wearable devices 102, receive data generated by user 104 of ear-wearable devices 102 as illustrated in FIG. 1, receive and send data, receive and send messages, and so on. In some examples, communication unit(s) 304 may include wireless transmitters and receivers that enable computing device 300 to communicate wirelessly with the other computing devices. For instance, in the example of FIG. 3, communication unit(s) 304 include a radio 306 that enables computing device 300 to communicate wirelessly with other computing devices, such as car-wearable devices 102 (FIG. 1). Examples of communication unit(s) 304 may include network interface cards, Ethernet cards, optical transceivers, radio frequency transceivers, or other types of devices that are able to send and receive information. Other examples of such communication units may include BLUETOOTH™, 3G, 4G, 5G, and WI-FI™ radios, Universal Serial Bus (USB) interfaces, etc. Computing device 300 may use communication unit(s) 304 to communicate with one or more ear-wearable devices (e.g., ear-wearable devices 102). Additionally, computing device 300 may use communication unit(s) 304 to communicate with one or more other devices.

Output device(s) 310 may generate output. Examples of output include tactile, audio, and video output. Output device(s) 310 may include presence-sensitive screens, sound cards, video graphics adapter cards, speakers, liquid crystal displays (LCD), light emitting diode (LED) displays, or other types of devices for generating output. Output device(s) 310 may include display screen 312. In some examples, output device(s) 310 may include virtual reality, augmented reality, or mixed reality display devices.

Processor(s) 302 may read instructions from storage device(s) 316 and may execute instructions stored by storage device(s) 316. Processor(s) 302 may be similar to processors 118 as illustrated in FIG. 1 and provide similar functionality. Execution of the instructions by processor(s) 302 may configure or cause computing device 300 to provide at least some of the functionality ascribed in this disclosure to computing device 300 or components thereof (e.g., processor(s) 302). As shown in the example of FIG. 3, storage device(s) 316 include computer-readable instructions associated with operating system 320, application modules 322A-322N (collectively, “application modules 322”), a companion application 324, and one or more conversational practice assistant components 326. In examples where computing device 300 is part of remote computing system 106, application models 322 and companion application 324 (along with some hardware components, such as input devices 308 and/or output devices 310) may be omitted.

Execution of instructions associated with operating system 320 may cause computing device 300 to perform various functions to manage hardware resources of computing device 300 and to provide various common services for other computer programs. Execution of instructions associated with application modules 322 may cause computing device 300 to provide one or more of various applications (e.g., “apps,” operating system applications, etc.). Application modules 322 may provide applications, such as text messaging (e.g., SMS) applications, instant messaging applications, email applications, social media applications, text composition applications, and so on.

Companion application 324 is an application that may be used (e.g., by user 104 or another person) to interact with ear-wearable devices 102, view information about car-wearable devices 102, or perform other activities related to ear-wearable devices 102. Execution of instructions associated with companion application 324 by processor(s) 302 may cause computing device 300 to perform one or more of various functions. For example, execution of instructions associated with companion application 324 may cause computing device 300 to configure communication unit(s) 304 to receive data from car-wearable devices 102 and use the received data to present data to a user, such as user 104 or a third-party user. For instance, companion application 324 may be used to provide calendar information, voice sample information, and so on. In some examples, companion application 324 is an instance of a web application or server application. In some examples, such as examples where computing device 300 is a mobile device or other type of computing device, companion application 324 may be a native application.

Conversational practice assistant components 326 may perform some or all tasks of conversational practice assistant 110. Conversational practice assistant components 326 may be distributed and/or replicated among multiple computing devices, including one or more of ear-wearable devices 102, devices of local computing system 106, and/or remote computing system 108.

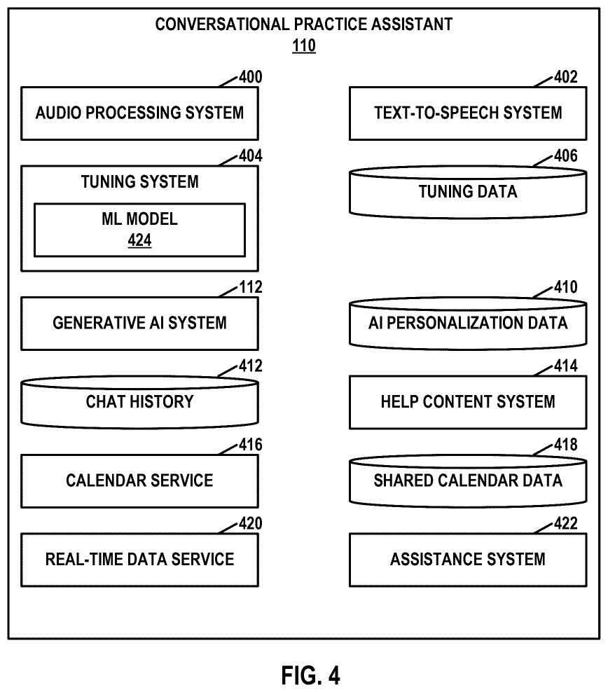

FIG. 4 is a block diagram illustrating example components of conversational practice assistant 110, in accordance with one or more techniques of this disclosure. The components of conversational practice assistant 110 may be within a single computing device or may be distributed among two or more devices, including ear-wearable devices 102, local computing system 106, and remote computing system 108. For example, an ear-wearable device such as one or more of ear-wearable devices 102 may implement the components of conversational practice assistant 102.

In the example of FIG. 4, conversational practice assistant 110 includes an audio processing system 400, a text-to-speech system 402, a tuning system 404, tuning data 406, a generative AI system 112, AI personalization data 410, a chat history 412, a help content system 414, a calendar service 416, shared calendar data 418, a real-time data service 420, and an assistance system 422. Conversational practice assistant 110 may be an AI-enhanced personal assistant configured to use one or more of natural language processing, information extraction, large language models, and other types of AI and machine learning models.

Conversational practice assistant 110 includes audio processing system 400. Audio processing system 400 may include one or more machine learning models trained to extract information from audio data received by conversational practice assistant 110. For example, audio processing system 400 may receive audio data and perform natural language processing to determine the semantic content of speech in the audio data. Audio processing system 400 may process the audio data to obtain other information, such as information about acoustic conditions. For example, audio processing system 400 may process the audio data to determine whether a user, such as user 104 as illustrated in FIG. 1, is not currently engaged in an activity where it could be distracting or annoying to user 104 to interact with conversational practice assistant 110 (e.g., user 104 may find it annoying if they are watching TV and conversational practice assistant 110 tries to initiate an interaction).

Conversational practice assistant 110 may use audio processing system 400 to ensure that conversational practice assistant 110 is communicating with user 104 and not accidentally communicating with another individual. Conversational practice assistant 110 may use a particular voice algorithm of audio processing system 400 to process received audio and to verify the identity of the speaker of the audio. Conversational practice assistant 110 may additionally store voiceprints or other audio identifiers for use in identifying speakers and user 104. For example, conversational practice assistant 110 may use one or more voice algorithms to ensure that conversational practice assistant 110 is conversing with user 104 and not a caregiver in the same room as user 104.

Conversational practice assistant 110 may use audio processing system 400 to perform environmental classification. Conversational practice assistant 110 may classify environments to determine whether user 104 is in an environment that is quiet and would be appropriate to initiate a conversation with user 104. For example, conversational practice assistant 110 may practice conversations with user 104 in environments that audio processing system 400 has classified as low ambient noise. Based on determining that user 104 is in an environment in which it would be appropriate to initiate a conversation, conversational practice assistant 110 may provide a conversation initiator to user 104.

Conversational practice assistant 110 includes text-to-speech system 402. Text-to-speech system 402 may include one or more machine learning models trained to convert text to audio data representing speech. Conversational practice assistant 110 may use text-to-speech system 402 to convert text generated by conversational practice assistant 110 into audio data that includes speech intelligible by a human user. Conversational practice assistant 110 may provide the audio data generated by text-to-speech system 402 to one or more devices capable of generated audio output such as car-wearable devices 102 as illustrated in FIG. 1.

Conversational practice assistant 110 includes tuning system 404. Tuning system 404 may be a process, module, or other type of software component configured to manage one or more aspects of ear-wearable devices 102. Tuning system 404 may suggest adjustments (or may automatically adjust aspects of ear-wearable devices 102. Tuning system 404 may store data regarding adjustments and the configuration of ear-wearable devices 102 in tuning data 406. Tuning data 406 may include data regarding adjustments to ear-wearable devices 102. Tuning system 404 may use tuning data 406 to suggest or make adjustments to one or more aspects of ear-wearable devices 102. In some examples, tuning system 404 may use a trained ML model such as ML model 424 to predict adjustments to the one or more aspects of ear-wearable devices 102. ML model 424 may be trained based on adjustment histories from user 104 and/or a population of users, including tuning data 406.

Conversational practice assistant 110 includes generative AI system 112. Generative AI system 112 may include one or more machine learning models, such as an LLM, that generate textual responses to prompts. For example, generative AI system 112 may use an LLM to generate a textual response to a prompt from user 104. In addition, generative AI system 112 may be configured with conversation guardrails such as guardrails against “hallucinations” by an LLM or another model. For example, generative AI system 112 may perform quality control on generated responses to verify the accuracy of the responses. Generative AI system 112 may directly process input such as multi-modal inputs without requiring conversion of the input to text. For example, generative AI system 112 may process audio input without first requiring the audio input to be converted to text.

Generative AI system 112 may personalize responses to particular users such as user 104. Generative AI system 112 may store information regarding user preferences and personalization in a data store such as AI personalization data 410. Knowledge base 114 may include AI personalization data 410. In some examples, AI personalization data 410 stores ontological data representing at least a portion of knowledge base 114. AI personalization data 410 may include data that generative AI system 112 may use to personalize responses to user 104. For instance, AI personalization data 410 may include tuning data 406, user personalization data, insights, recommendations, and so on. AI personalization data 410 may also store information regarding conversational guardrails that indicate topics and points of discussion that should be avoided when interacting with user 104. In another example, AI personalization data 410 may include personalization configured by user 104. In yet another example, AI personalization data 410 may include data regarding conversational guardrails that restrict topics and other points of conversation from being discussed by conversational practice assistant 110.

AI personalization data 410 may include summaries of conversations involving user 104 and other individuals. Conversational practice assistant 110 may prompt generative AI system 112 to generate either or both natural language summaries of the conversation and ontological data representing semantic content of the conversations. Conversational practice assistant 110 may store the summaries and/or ontological data in AI personalization data 410.

In some examples, the ontological data stored in AI personalization data 410 may include ontological data indicating which topics user 104 and other individuals like to discuss and which topics that they would prefer to avoid (e.g., controversial topics). Conversational practice assistant 410 may prompt generative AI system 112 to identify such topics based on transcripts of past conversions or other data already stored in AI personalization data 410.

In some examples, conversational practice assistant 110 monitors a conversation between user 104 and another individual. As part of monitoring the conversation, conversational practice assistant 110 may involve periodically provide transcripts of segments of the conversation to generative AI system 112 and may request summaries of topics discussed during the segments of the conversation. Furthermore, while monitoring the conversation, conversational practice assistant 110 may determine that the conversation has reached a topic that the other individual prefers not to discuss. In some examples, while monitoring the conversation, conversational practice assistant 110 may periodically provide transcripts of segments of the conversation to generative AI system 112 with a request to indicate whether any topics were discussed that the other individual prefers not to discuss. Conversational practice assistant 110 or generative AI system 112 may determine that the topic is one that the other individual prefers not to discuss based on ontological information retained in AI personalization data 410. Conversational practice assistant 110 may generate and provide a prompt to generative AI system 112 that includes a request to generate a natural language reminder for user 104 that the topic is one the other individual does not like to discuss and provides audio data of the natural language reminder to ear-wearable devices 102. Conversational practice assistant may provide the reminder generated by generative AI system 112 to user 104. Conversational practice assistant 110 may use a similar process to provide positive feedback for user 104 discussing topics that the other individual prefers to discuss.

In addition, conversational practice assistant 110 may use the ontological information stored in AI personalization data 410 to remind user 104 of topical guardrails while practicing conversations. For example, conversational practice assistant 110 may practice a conversation with user 104 that simulates a conversation with the grandson of user 104. Conversational practice assistant 110 may remind user 104 during the conversation that the grandson finds hockey to be an uninteresting subject and quickly loses interest in a conversation when hockey is brought up. Conversational practice assistant 110 may use AI personalization data 410 to determine the conversation guardrail about hockey and provide a prompt to generative AI system 410 for generation of a natural language reminder that is to be provided to user 104 by ear-wearable devices 102.

Conversational practice assistant 110 may use voice identification information in AI personalization data 410 for use in identifying the voice of user 104 within audio data. For example, conversational practice assistant 110 may use a voice detection algorithm stored in AI personalization data 410 to identify the voice of user 104 within audio data received by conversational practice assistant 110. Conversational practice assistant 110 may be better equipped to identify the voice of user 104 by nature of receiving audio data via ear-wearable devices 102 rather than other computing devices. In an example, while in a conversation with user 104 via ear-wearable devices 102, conversational practice assistant 110 uses own-voice detection and/or a voice algorithm to filter out other voices from the audio data generated by ear-wearable devices 102. Conversational practice assistant 110 may use the own-voice detection and/or voice algorithm to avoid confusing the voices of other individuals with the voice of user 104. In addition, conversational practice assistant 110 may use the own-voice detection to resolve voice collision among multiple individuals. For example, conversational practice assistant 110 may use own-voice detection to determine what user 104 says when ear-wearable devices 102 detect multiple individuals speaking at once.

Conversational practice assistant 110 may use one or more components of car-wearable devices 102 to perform the own-voice detection. For example, one or more of ear-wearable devices 102 may apply an algorithm that extracts a speech signal of user 104 from one or more audio signals generated by one or more microphones. The one or more ear-wearable devices 102 may send the audio data corresponding to the extracted speech signal of the user to a computing system that provides conversational practice assistant 110. In some examples, ear-wearable devices 102 may apply an algorithm to extract a speech signal of user 104 from one or more audio signals generated by the one or more microphones of ear-wearable devices 102. Ear-wearable devices 102 may provide audio data corresponding to the extracted speech signal of user 104 to conversational practice assistant 110.

Ear-wearable devices 102 and conversational practice assistant 110 may use information from inertial measurement units (IMUs) of ear-wearable devices 102 to identify the voice of user 104 from the voices detected by the microphones of car-wearable devices 102. Virtual personal 102 may correlate the vibrations detected by the IMUs to audio data generated by the microphones of ear-wearable devices to identify the voice of user 104 from the audio data. Conversational practice assistant 110 may use the own-voice detection to improve descriptions and summaries of conversation by avoiding confusing the voices of other individuals as the voice of user 104.

Conversational practice assistant 110 may manage the storage location of information to maintain the privacy of user 104. For example, generative AI system 112 may operate at remote computing system 108. In this example, conversational practice assistant 110 may store sensitive information locally at local computing system 106 and may transfer sensitive information to remote computing system 108 for use by generative AI system 112 only when needed. The sensitive information may include certain types of information, such as names, addresses, birthdays, jobs, pets, hobbies, favorite things, recent activities, medical information, and other information such as information obtained during conversations between user 104, other individuals, and conversational practice assistant 110. In some examples, local computing system 106 stores AI personalization data 410. Conversational practice assistant 110 may transmit some or all of AI personalization data 410 to remote computing system 108.

In an example, conversational practice assistant 110 maintains information regarding an upcoming appointment locally in local computing system 106. In the example, conversational practice assistant 110 receives a request from user 104 asking, “When is my upcoming doctor's appointment?” Based on the request, conversational practice assistant 110 sends information regarding the calendar of user 104 to remote computing system 108 for processing by one or more systems such as generative AI system 112. Conversational practice assistant 110 may identify the information in the calendar of user 104 regarding the appointment and only send that information to remote computing system 108 to limit the amount of personal information outside of local computing system 106. In some examples, conversational practice assistant 110 may transfer data from local computing system 106 to remote computing system 108 only when necessary to generate a response to an interaction with user 104, such as to generate a conversation initiator. In another example, conversational practice assistant 110 causes local computing system 106 to only provide the minimum amount of information necessary to satisfy a request for information from remote computing system 108. In other examples, local computing system 106 may store an encrypted backup of the information on another computing system such as remote computing system 108 or another computing system. Local computing system 106 may store a backup that is encrypted to another device without storing the key to the backup on the same device to ensure the security of the information within the backup.

Conversational practice assistant 110 may limit the amount of information obtained from local computing system 106 and stored within remote computing system 108. For example, remote computing system 108 may receive a request by conversational practice assistant 110 to generate a response to an inquiry by user 104. Remote computing system 108 may then determine the information necessary to generate the response and may obtain the information from local computing system 106. Remote computing system 108 may determine the minimum amount of information needed to complete the request to limit the amount of personal information of user 104 stored by remote computing system 108. Remote computing system 108 generates the response using the received information and promptly deletes the information when no longer needed. Remote computing system 108 may promptly delete the information to avoid retaining information that is not necessary for any ongoing tasks (e.g., generating a response to a query from user 104 or providing a conversation initiator) to maintain the privacy of user 104 and other individuals. As part of maintaining privacy, remote computing system 108 may store information received from other sources in local computing system 106. In an example, remote computing system 108 receives information from a family member of user 104 via a webpage. Remote computing system 108 may provide the information to local computing system 106 to be stored and promptly delete the information from the memory of remote computing system 108. Remote computing system 108 may store the information in local computing system 106 to avoid retaining personal information within the memory of remote computing system 108.

Conversational practice assistant 110 includes chat history 412. Chat history 412 may include a history of interactions between user 104 and conversational practice assistant 110 that generative AI system 112 may use to generate responses. In addition, chat history 412 may include ontological data that relates information about the interactions with other information and the identities of individuals. In an example, conversational practice assistant 110 may record information regarding a conversation between user 104 and a family member of user 104 for later use by conversational practice assistant 110. In addition, conversational practice assistant 110 records ontological data relating one or more pieces of information of the conversation with user 104, the family member, and the identities of other individuals discussed during the conversation. In another example, conversational practice assistant 110, during a conversation with user 104, records answers by user 104 to questions posed by conversational practice assistant 110. Conversational practice assistant 110 compares the answers given by user 104 and stored in chat history 412 to verified information stored by conversational practice assistant 110 to determine whether user 104 has provided correct information. In addition, conversational practice assistant 110 may use the information stored in chat history 412 to determine how well user 104 remembers different pieces of information.

Conversational practice assistant 110 includes help content system 414. Help content system 414 may generate response to requests from user 104 for help regarding ear-wearable devices 102. In an example, conversational practice assistant 110 receives a request from user 104 to adjust the noise cancellation level of hear instruments 102. Help content system 414 processes the request from user 104 and causes ear-wearable devices 102 to adjust the noise cancellation level.

Conversational practice assistant includes calendar service 416 and shared calendar data 418. Calendar service 416 may be a process, module, or other type of software component configured to manage a digital calendar. For example, calendar service 416 may maintain information regarding different events for user 104 such as medical appointments and family events. Conversational practice assistant 110 may interact with user 104 to obtain information for calendar service 416. In addition, conversational practice assistant 110 may cause calendar service 416 to update a calendar in response to determining that, during a conversation, user 104 has indicated an upcoming event or change to a calendar. Calendar service 416 may store information regarding events in shared calendar data 418.

Calendar service 416 may use shared calendar data 418 to provide reminders and otherwise provide chronological data to user 104. In addition, calendar service 416 may store information regarding a calendar associated with user 104. For example, calendar service 416 may maintain information regarding events and other information for user 104 in shared calendar data 418. In addition, calendar service 416 may obtain and store information from other individuals associated with user 104 such as family members of user 104. For example, calendar service 416 may receive information from a webpage configured to enable individuals associated with user 104 to provide information such as calendar events to conversational practice assistant 110. Conversational practice assistant 110 may obtain the information from the individuals associated with user 104 and store the information in shared calendar data. In addition, conversational practice assistant 110 may enable the other individuals to update and modify a calendar of user 104. For example, calendar service 416, based on receiving input from an individual associated with user 104, updates the calendar stored in shared calendar data 418. Calendar service 416 may enable conversational practice assistant 110 to provide reminders associated with upcoming events and combine calendar information with reminders. For example, conversational practice assistant 110 can combine holidays of the calendar with reminders to buy presents and events away from home with reminders to make travel plans.

Conversational practice assistant 110 includes real-time data service 420. Real-time data service 420 may be a process, module, plugin, or other type of software service. Real-time data service 420 may retrieve information from live information sources (e.g., weather data, stock price data, news data, etc.) to provide to ear-wearable devices 102. Conversational practice assistant 110 may cause real-time data service 420 to obtain information in response to a request from user 104. For example, conversational practice assistant 110 receives a request from user 104 to provide a weather forecast. Based on the request, conversational practice assistant 110 causes real-time data service 420 to poll one or more sources of weather information and provide weather information to conversational practice assistant 110. Conversational practice assistant 110 causes one or more devices such as ear-wearable devices 102 to communicate the information to user 104. In some examples, real-time service 416 may obtain information for use by conversational practice assistant 110 for use in a conversation with user 104, such as a conversation to assist user 104 in retaining conversation skills.

Conversational practice assistant 110 includes assistance system 422. Assistance system 422 may be a process, module, plugin, or other type of software service. Assistance system 422 may coordinate activities of other components of conversational practice assistant 110. In an example, assistance system 422 coordinates, in response to conversational practice assistant 110 receiving a question regarding an upcoming medical appointment. Assistance system 422 coordinates retrieval of information regarding the appointment from shared calendar data 418 by calendar service 416. Assistance system 422 causes calendar service 416 to provide the data to audio processing system 400 for conversion to audio data to be provided to ear-wearable devices 102. Generative AI system 112 may generate natural language for output by ear-wearable devices 102. In some examples, an activity level and/or types of activities engaged in by user 104 may be detected from signals generated by ear-wearable devices 102 (e.g., using the techniques described in U.S. Patent Publication 2022/0279266, the entirety of which is incorporated by reference).

One or more components of conversational practice assistant 110, such as assistance system 422, may manage dialog pairs. Each interactive conversation may include a series of dialog pairs. In each of the dialog pairs, user 104 may say something and conversational practice assistant 110 may “say” something. That is, each of the dialog pairs includes an expression by user 104 and an expression by conversational practice assistant 110. Local computing system 106 may perform the actions of operation 700 for some or each of the dialog pairs in the interactive conversation. In some examples, conversational practice assistant 110 may initiate the interactive conversation.

Assistance system 422 may receive user expression data from one or more car-wearable devices worn by the user. For example, assistance system 422 may receive audio data representing a vocalization of user 104. In such examples, audio processing system 400 may convert the audio data to text data. In other words, audio processing system 400 may generate, based on the audio data, a textual representation of the vocalization. Assistance system 422 may receive text data or other types of data representing the user expression data. The user expression data represents an expression of the user in the dialog pair. In some examples, generative AI system 112 may directly process the audio data without requiring the generation of a textual representation of the vocalization.

Furthermore, assistance system 422 may retrieve user-specific data from knowledge base 114 associated with user 104. In some examples, assistance system 422 retrieves the user-specific data based on the expression of user 104. For example, if the expression of user 104 mentions specific concepts (e.g., particular persons, sports teams, places, actions, activities, etc.), assistance system 422 may search knowledge base 114 for data related to those concepts. In one example, if the concept includes a specific person, the types of information that may be received may include information about that person's relationship to user 104, information about previous conversations involving that person and user 104, information about that person's like and dislikes, and so on. Other types of user-specific data that can be retrieved from knowledge base 114 may include one or more of events of a calendar, personal information of the user, information regarding previous interactions between user 104 and conversational practice assistant 110, or information regarding previous interactions between user 104 and one or more other individuals. Assistance system 422 may parse the expression of user 104 to identify the concepts. Searching knowledge base 114 may involve automatically generating a search query.

As discussed elsewhere in this disclosure, conversational practice assistant 110 may add such information to knowledge base 114 based on the content of past conversations whose audio is captured by ear-wearable devices 102. Thus, the involvement of ear-wearable devices 102 in both knowledge capture and for engaging in interactive conversations with conversational practice assistant 110 may greatly decrease the complexity of how conversational practice assistant 110 can obtain information needed to engage in relevant virtual conversations with user 104, such as practice conversations that may help user 104 feel prepared for engagement with real people. For instance, manual data entry can be avoided because the information needed to engage in such interactive conversations may be collected by conversational practice assistant 110 as part of the routine operation of ear-wearable devices 102.

Assistance system 422 may generate, based on the user-specific data and the user expression data, an augmented prompt that requests generative AI system 112 to generate an expression of conversational practice assistant 110 in the dialog pair. The augmented prompt may include the user-specific data retrieved from knowledge base 114. The augmented prompt may also include information from previous dialog pairs of the interactive conversation. In this way, generative AI system 112 may have context to generate an appropriate expression. The augmented prompt may also include the user expression data (e.g., a textual representation of the vocalization of user 104) and a request to generate an expression of conversational practice assistant 110 in the conversation. In some examples where the interactive conversation is a simulated conversation between user 104 and another individual, the augmented prompt may request generative AI system 112 to pretend to be the other individual.

In some examples, conversational practice system 112 receives, via a microphone on an ear-wearable device, an audio input corresponding to a user response to a conversation initiator. Local computing system 106 may generate, based on the audio data, a textual representation of the vocalization. Local computing system 106 may cause generative AI system 112 to generate, based on the textual representation, a response to the user response. In some examples, local computing system 106 may generate the textual representation and the conversation initiator.

In some examples, conversational practice assistant 110 may receive sensor data from ear-wearable devices 102. Conversational practice assistant 110 may generate, based on the sensor data, emotional state data indicating a predicted emotional state of user 104. Assistance system 422 may generate a conversation initiator and/or response based on the user-specific data, the user expression data, and also the emotional state data. As noted elsewhere in this disclosure, ear-wearable devices 102 may be uniquely situated to detect signals indicating the user's emotions. For instance, ear-wearable devices 102 are well situated to detect galvanic skin response, head motions, overall activity, heart rate, blood pressure, aspects of the user's own voice, and so on, that might provide indications of the emotional state of user 104. Local computing system 106 may generate emotional state data based on the sensor data generated by ear-wearable devices 102 that indicates a predicted emotional state of user 104. Being able to include such emotional state data in a prompt provided to generative AI system 112 may further enhance the ability of generative AI system 112 to facilitate the engagement of conversational practice assistant 110 in meaningful interactive conversations with user 104. For instance, the words user 104 says may indicate one emotional state, but with the context of the emotional state data, generative AI system 112 may be able to determine that user 104 is currently in another emotional state and respond accordingly. Conversational practice assistant 110 may provide conversation initiators to ear-wearable devices 102 that are generated based on the emotional state data. For instance, conversational practice assistant 110 may modify a conversation initiator to include different natural language phrases and/or tone based on the emotional state data. In some examples, conversational practice assistant 110 may use local computing system 106 to generate the conversation initiators that are based on emotional state data.

Furthermore, assistance system 422 may store emotional state data from conversations with other people or conversational practice assistant 110 in knowledge base 114. For instance, assistance system 422 may receive sensor data from one or more of ear-wearable devices 102 during an interactive conversation between user 104 and another person. Assistance system 422 may generate, based on the sensor data, emotional state data indicating a predicted emotional data of the user during the interactive conversation. Assistance system 422 may store, in knowledge base 114, the emotional state data and information about the second interactive conversation. The user-specific data retrieved from knowledge base 114 during an interactive conversation with conversational practice assistant 110 may include the emotional state data.

In some examples, personally identifying information is not included in the augmented prompt or augmented conversation initiator. For instance, assistance system 422 may replace the names of people with codes and may replace such codes in the expression of conversational practice assistant 110 with the names. Assistance system 422 may replace the names of people to maintain the confidentiality of information maintained by conversational practice system 112.

In some examples, an activity level and/or types of activities engaged in by user 104 may be detected from signals generated by ear-wearable devices 102 (e.g., using the techniques described in U.S. Patent Publication 2022/0279266, the entirety of which is incorporated by reference). Assistance system 422 may include information about the user's activities in knowledge base 114 and in augmented prompts. Because of their position on the user's head, ear-wearable devices 102 may be uniquely situated to detect activities performed by user 104. Thus, conversational practice assistant 110 may be better able to engage with user 104 about activities performed by user 104. Conversely, lack of engagement in activities may indicate illness or depression. This information could also be useful context for generative AI system 112.

Assistance system 422 may obtain the expression of conversational practice assistant 110 from generative AI system 112. In some examples, such as examples where generative AI system 112 is implemented on remote computing system 108, local computing system 106 may transmit the augmented prompt to remote computing system 108 (e.g., via a communication network) and local computing system 106 may receive the expression of conversational practice assistant 110 from remote computing system 108 (e.g., via the communication network). In some such examples, the transmission is encrypted.

Additionally, assistance system 422 may cause the one or more ear-wearable devices 102 to output audio based on the expression of conversational practice assistant 110. For example, assistance system 422 may convert the expression of conversational practice assistant 110 to audio data and transmit the audio data to one or more of car-wearable devices 102 for output. In other words, text-to-speech system 402 may generate audio data representing a vocalization of the expression of conversational practice assistant 110 and local computing system 106 may transmit the audio data to one or more ear-wearable devices 102. In another example, assistance system 422 may transmit the expression of conversational practice assistant 110 to one or more of ear-wearable devices 102 and ear-wearable devices 102 may convert the expression of conversational practice assistant 110 to audio.

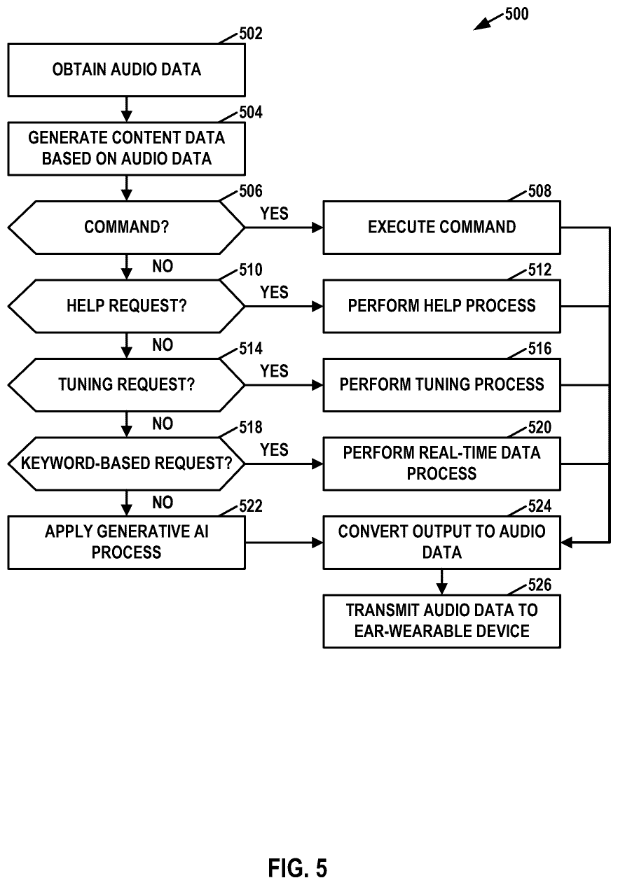

FIG. 5 is a flowchart illustrating an example operation 500 of conversational practice assistant 110 in accordance with one or more techniques of this disclosure. Other examples of this disclosure may include more, fewer, or different actions. In some examples, actions in the flowcharts of this disclosure may be performed in parallel or in different orders.

In the example of FIG. 5, audio processing system 400 may obtain audio data (502). For instance, audio processing system 400 may receive the audio data from one or more of ear-wearable devices 102. Audio processing system 400 may generate content data based on the audio data (504). For example, audio processing system 400 may perform speech recognition and natural language processing (NLP) to extract semantic content data from the audio data. In some examples, audio processing system 400 may extract non-speech data, such as data indicating acoustic conditions, from the audio data. Although not shown in the example of FIG. 5, conversational practice assistant 110 may also obtain other content data, such as motion data, sensor data, and so on.

Assistance system 422 may determine, based on the content data, whether user 104 is providing a command to conversational practice assistant 110 (506). Example commands may include direct requests to change volume, turn on or off features, change acoustic programs, and so on. If user 104 is providing a command to conversational practice assistant 110 (“YES” branch of 506), assistance system 422 may send instructions to ear-wearable devices 102 to execute the command (508). Assistance system 422 may also generate or retrieve textual output data indicating a response to the command (e.g., “ok, turning up the volume”). Text-to-speech system 402 may convert the textual output data to audio data (524) and assistance system 422 may transmit the audio data to ear-wearable devices 102 (526).

Otherwise, if user 104 is not providing a command to conversational practice assistant 110 (“NO” branch of 506), assistance system 422 may determine whether the content data represents a help request (510). Example help requests may include requests for information about ear-wearable devices 102. If the content data represents a help request (“YES” branch of 510), help content system 414 may perform a help process to generate a help response (512). The help process may use a keyword-based search to retrieve predefined text that corresponds to the help request. In addition, the help process may retrieve information such as calendar information relevant to the request. Text-to-speech system 402 may convert textual output data of help content system 414 to audio data (524) and assistance system 422 may transmit the audio data to ear-wearable devices 102 (526).

If the content data does not represent a help request (“NO” branch of 510), tuning system 404 may perform a tuning process to recommend or apply one or more adjustments to aspects of ear-wearable devices 102 (516). In some examples, tuning system 404 may guide user 104 through a self-fit or auto-fit process. Text-to-speech system 402 may convert textual output data of the tuning process to audio data (524) and assistance system 422 may transmit the audio data to ear-wearable devices 102 (526).

If assistance system 422 determines that the content data represents a keyword-based request (518). A keyword-based request may include one or more keywords that indicate that user 104 is seeking real-time information, such as news or weather information. If assistance system 422 determines that the content data represents a keyword-based request (“YES” branch of 518), real-time data service 420 may perform a real-time data process (520). Performance of the real-time data process may involve retrieval of information from online sources, such as webpages, application programming interfaces (APIs), and so on. Text-to-speech system 402 may convert textual output data of the real-time data process to audio data (524) and assistance system 422 may transmit the audio data to ear-wearable devices 102 (526).

If assistance system 422 determines that the content data does not represent a keyword-based request (“NO” branch of 518), generative AI system 112 may perform a generative AI process to generate a response (522). As part of performing the generative AI process, generative AI system 112 may apply an LLM one or more times to generate the response. In some examples, the response may be conversational in tone, similar to what a user might experience using a chatbot, such as ChatGPT, or Google BARD. In some examples, the response may be to add data to shared calendar data 418, AI personalization data 410, and so on. Chat history 412 may include a record of interactions of user 104 with conversational practice assistant 110, including records of interactions with generative AI system 112. In some examples, generative AI system 112 may automatically summarize conversations that user 104 had with other people, generate data indicating performance of activities, and so on, and store the resulting data as AI personalization data 410. Generative AI system 112 (or another component of conversational practice assistant 110) may use the stored data for various purposes, such as providing reminders, cognitive support, and so on. Thus, not all responses generated by generative AI system 112 are for immediate responses to user 104 and generative AI system 112 may generate a response (e.g., for internal data storage) without immediate user 104 involvement. Text-to-speech system 402 may convert textual output data of the real-time data process to audio data (524) and assistance system 422 may transmit the audio data to ear-wearable devices 102 (526).

Assistance system 422 may determine whether the content data represents a command, help request, tuning request, keyword-based request, or other type of request based on keyword matching within the content data, based on a semantic analysis of the content data, or in another way. In some examples, calendar service 416 may operate outside of operation 500 so that calendar service 416 may provide reminders separate that are not in response to requests from user 104. In some examples, operation 500 may include querying web-resources to obtain information unavailable within conversational practice assistant 110. Operation 500 may avoid use of generative AI system 112 for tasks that do not require complex processing. This may save computational resources.

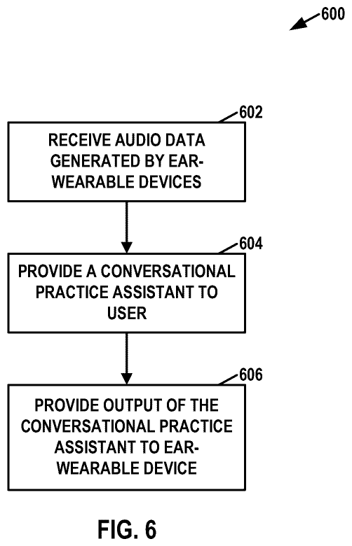

FIG. 6 is a flowchart illustrating an example operation 600, in accordance with one or more techniques of this disclosure. In the example of FIG. 6, a computing system (e.g., local computing system 106, remote computing system 108, and/or components of one or more of ear-wearable devices 102) may receive audio data generated by one or more ear-wearable devices 102 worn at or near one or more ears of user 104 (602). The audio data may be first audio data and ear-wearable devices 102 may be configured to generate the first audio data by applying signal processing to second audio data generated by microphones of the one or more ear-wearable devices.

The computing system may provide a conversational practice assistant 110 to user 104 (604). Conversational practice assistant 110 may be configured to generate, based on the audio data, output to assist user 104. The computing system may provide the output to the one or more ear-wearable devices 102 (606). Ear-wearable devices 102 may be configured to generate auditory stimuli based on the output.

In some examples, as part of providing conversational practice assistant 110, the computing system applies a Large Language Model (LLM) to generate a response. The output of conversational practice assistant 110 may be based on the response. In some examples, providing conversational practice assistant 110 may further comprise generating a prompt based on the audio data and applying the LLM to the prompt to generate the response.

In some examples, conversational practice assistant 110 is configured to learn a routine of the user based at least in part on the audio data and generate the output based on the routine of the user. The output of conversational practice assistant 110 may be based on the routine of the user and include a reminder to perform an activity.

In some examples, conversational practice assistant 110 is configured to determine, based on the audio data, whether an event has occurred and to generate the output indicating whether the event has occurred. For instance, the event may be user 104 taking medication. In some examples, conversational practice assistant 110 is configured to access a calendar and the output is based on events in the calendar.

In some examples, the audio data represents a voice of a person with whom the user is interacting, and the output generated by the conversational practice assistant includes information about the person. In some such examples, the information about the person includes information about interactions between the person and the user. Conversational practice assistant 110 may be configured to learn the information about the person based on the audio data received from ear-wearable devices 102.

Furthermore, in some examples, the output generated by conversational practice assistant 110 includes a recommended or automatic adjustment to one or more aspects of the one or more ear-wearable devices 102. In some such examples, the audio data may include a request from the user to improve sound quality of the one or more ear-wearable devices 102. In some examples, conversational practice assistant 110 is configured to receive health data for the user. In some examples, conversational practice assistant 110 extracts semantic content of speech represented by the audio data.

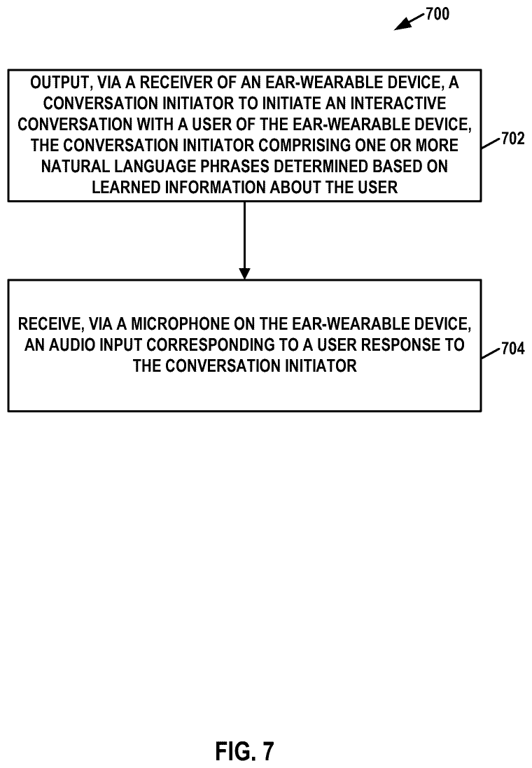

FIG. 7 is a flowchart illustrating an example operation 700 for delivering conversational practice, in accordance with one or more techniques of this disclosure. For the purposes of clarity, FIG. 7 is discussed in the context of FIG. 1. One or more devices such as local computing system 106, remote computing system 108, and/or ear-wearable devices 102 may perform operation 700 as part of providing conversational practice assistant 110. For instance, assistance system 422 may be implemented on local computing system 106 and may perform the actions of operation 700. As discussed above, conversational practice assistant 110 may be configured to conduct an interactive conversation with user 104.

An ear-wearable device, such as one or more of ear-wearable devices 102, provides a conversation initiator to initiate an interactive conversation with a user such as user 104, the conversation initiator comprising one or more natural language phrases determined based on learned information about user 104 (702). Ear-wearable devices 102 may provide the conversation initiator based on one or more factors. For example, car-wearable devices 102 may provide the conversation initiator in response to determining that user 104 is available to participate in conversational practice. Ear-wearable devices 102 may generate the conversation initiator based on learned information such as information stored in knowledge base 114. For example, ear-wearable devices 102 may generate the conversation initiator based on learned information regarding topics of interest to user 104 that are stored in knowledge base 114 that is stored in memory of local computing system 106. Ear-wearable devices 102 may use generative AI system 112 to generate the conversation initiator. In an example, conversational practice assistant 110 causes generative AI system 112 to generate a conversation initiator and provide the conversation initiator to ear-wearable devices 102. Ear-wearable devices 102 provide the conversation initiator to user 104.

Ear-wearable devices 102 receive, via a microphone on one or more of car-wearable devices 102, an audio input corresponding to a user response to the conversation initiator (704). Ear-wearable devices 102 may receive spoken input of user 104 responding to the conversation initiator. For example, ear-wearable devices 102 may receive spoken input as part of a simulated conversation between user 104 and an individual simulated by conversational practice assistant 110.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processing circuits to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, cache memory, or any other medium that can be used to store desired program code in the form of instructions or data structures and that can be accessed by a computer. Also, any connection may be considered a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transitory, tangible storage media. Combinations of the above should also be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
providing, by a local computing system associated with a user, a conversational practice assistant configured to conduct an interactive conversation with the user, wherein the interactive conversation includes a series of dialog pairs, each of the dialog pairs includes one or more expressions by the user and one or more expressions by the conversational practice assistant, and providing the conversational practice assistant comprises, for at least one dialog pair of the series of dialog pairs:
receiving, by the local computing system, user expression data from one or more ear-wearable devices worn by the user, wherein the user expression data represents a first expression of the user in the dialog pair;
retrieving, by the local computing system, user-specific data from a knowledge base associated with the user;
generating, by the local computing system, based on the user-specific data and the user expression data, a prompt that requests a generative artificial intelligence (AI) system to generate a second expression of the conversational practice assistant in the dialog pair;
obtaining, by the local computing system, the second expression of the conversational practice assistant from the generative AI system; and
causing, by the local computing system, the one or more ear-wearable devices to output audio based on the second expression of the conversational practice assistant.

2. The method of claim 1, wherein:
providing the conversational practice assistant further comprises:
receiving, by the local computing system, sensor data from the one or more ear-wearable devices; and
generating, by the local computing system, based on the sensor data, emotional state data indicating a predicted emotional state of the user, and
generating the prompt comprises generating, by the local computing system, the prompt based on the user-specific data, the user expression data, and the emotional state data.

3. The method of claim 1, wherein:
the interactive conversation is a first interactive conversation, the method further comprising:
receiving, by the local computing system, sensor data from the one or more ear-wearable devices during a second interactive conversation between the user and another person occurring prior to the first interactive conversation;
generating, by the local computing system, based on the sensor data, emotional state data indicating a predicted emotional data of the user during the second interactive conversation; and
storing, by the local computing system, in the knowledge base, the emotional state data and information about the second interactive conversation, and
the user-specific data retrieved from the knowledge base includes the emotional state data.

4. The method of claim 1, wherein the local computing system is local to the user and the knowledge base is stored at the local computing system.

5. The method of claim 1, wherein causing the one or more ear-wearable devices to output the audio comprises:
generating, by the local computing system, audio data representing a vocalization of the second expression of the conversational practice assistant; and
transmitting, by the local computing system, the audio data to the one or more ear-wearable devices.

6. The method of claim 1, wherein:
the user expression data comprises audio data representing a vocalization of the user,
providing the conversational practice assistant further comprises generating, by the local computing system, based on the audio data, a textual representation of the vocalization, and
generating the prompt comprises generating, by the local computing system, the prompt based on the user-specific data and the textual representation of the vocalization.

7. The method of claim 1, wherein the interactive conversation is a simulated conversation between the user and another individual and the prompt requests the generative AI system to pretend to be the other individual.

8. The method claim 1, wherein the user-specific data retrieved from the knowledge base includes one or more of:
events of a calendar,
personal information of the user,
information regarding previous interactions between the user and the conversational practice assistant, or
information regarding previous interactions between the user and one or more other individuals.

9. The method of claim 1, further comprising:
obtaining information regarding the user from one or more individuals via a webpage; and
storing the information in the knowledge base.

10. The method of claim 1, further comprising:
analyzing audio data from the one or more ear-wearable devices representing expressions in one or more conversations involving the user to extract information; and
storing the information in the knowledge base.

11. The method of claim 10, wherein the method further comprises:
determining, based on one or more factors, whether to store the information in the knowledge base, wherein the one or more factors include at least one of:
a determination that the user is currently discussing a sensitive topic,
a determination that the user is currently in a therapeutic session,
one or more privacy settings, or
a determination that the user has not requested that the local computing system to monitor the interactive conversation.

12. The method of claim 1, further comprising:
determining, by the local computing system and based one or more factors, whether to cause the conversational practice assistant to initiate the interactive conversation with the user.

13. The method of claim 12, wherein the one or more factors include one of:
a loneliness metric,
environmental conditions consistent with the user not being currently active, or calendar information of the user.

14. The method of claim 13, further comprising:
computing, by the local computing system, the loneliness metric, wherein computing the loneliness metric comprises obtaining information from the knowledge base that includes data regarding social interactions of the user; and
triggering, by the local computing system and based on the loneliness metric, the conversational practice assistant to initiate the interactive conversation.

15. A local computing system associated with a user, comprising:
a memory; and
one or more programmable processors in communication with the memory, and configured to:
provide a conversational practice assistant configured to conduct an interactive conversation with the user, wherein the interactive conversation includes a series of dialog pairs, each of the dialog pairs includes one or more expressions by the user and one or more expressions by the conversational practice assistant, and, to provide the conversational practice assistant, the one or more programmable processors are configured to, for at least one dialog pair of the series of dialog pairs:
receive user expression data from one or more ear-wearable devices worn by the user, wherein the user expression data represents a first expression of the user in the dialog pair, and the local computing system is associated with the user;
retrieve user-specific data from a knowledge base associated with the user;
generate, based on the user-specific data and the user expression data, a prompt that requests a generative artificial intelligence (AI) system to generate a second expression of the conversational practice assistant in the dialog pair;
obtain the second expression of the conversational practice assistant from the generative AI system; and
cause the one or more ear-wearable devices to output audio based on the second expression of the conversational practice assistant.

16. The local computing system of claim 15, wherein the interactive conversation is a simulated conversation between the user and another individual and the prompt requests the generative AI system to pretend to be the other individual.

17. The local computing system of claim 15, wherein:
the interactive conversation is a first interactive conversation, and wherein the one or more programmable processors further configured to:
receive sensor data from the one or more ear-wearable devices during a second interactive conversation between the user and another person occurring prior to the first interactive conversation;
generate, based on the sensor data, emotional state data indicating a predicted emotional data of the user during the second interactive conversation; and
store, in the knowledge base, the emotional state data and information about the second interactive conversation, and
wherein the user-specific data retrieved from the knowledge base includes the emotional state data.

18. The local computing system of claim 15, wherein the local computing system is local to the user and the knowledge base is stored at the local computing system.

19. The local computing system of claim 15, wherein to cause the one or more ear-wearable devices to output the audio, the one or more programmable processors are configured to:
generate audio data representing a vocalization of the second expression of the conversational practice assistant; and
transmit the audio data to the one or more ear-wearable devices.

20. One or more non-transitory computer-readable media configured with instructions that, when executed, cause one or more programmable processors of a local computing system to:
provide a conversational practice assistant configured to conduct an interactive conversation with a user, wherein the interactive conversation includes a series of dialog pairs, each of the dialog pairs includes one or more expressions by the user and one or more expressions by the conversational practice assistant, and, to provide the conversational practice assistant, the one or more programmable processors are configured to, for at least one dialog pair of the series of dialog pairs:
receive user expression data from one or more ear-wearable devices worn by the user, wherein the user expression data represents a first expression of the user in the dialog pair, and the local computing system is associated with the user;
retrieve user-specific data from a knowledge base associated with the user;
generate, based on the user-specific data and the user expression data, a prompt that requests a generative artificial intelligence (AI) system to generate a second expression of the conversational practice assistant in the dialog pair;
obtain the second expression of the conversational practice assistant from the generative AI system; and
cause the one or more ear-wearable devices to output audio based on the second expression of the conversational practice assistant.
